(19) United States
(12) Patent Application Publication
(10) Pub. No.: US 2026/0355863 A1
(43) Pub. Date: Nov. 12, 2026

(54) Monitoring Device for Monitoring an Energy-Beam Machining Process, Energy-Beam Machining Head, and Method for Monitoring an Energy-Beam Machining Process

(71) Applicant: Precitec GmbH & Co. KG, Gaggenau (DE)

(72) Inventor: Rainer Kraft, Ettlingen (DE)

(73) Assignee: Precitec GmbH & Co. KG, Gaggenau (DE)

(21) Appl. No.: 19/670,586

(22) Filed: May 7, 2026

(30) Foreign Application Priority Data
May 8, 2025 (DE) 10 2025 117 605.1
Dec. 30, 2025 (DE) 10 2025 155 350.5

(51) Int. Cl. B23K 26/70; B23K 26/082

(52) U.S. Cl. CPC B23K 26/705; B23K 26/082

(57) ABSTRACT

A monitoring device for monitoring an energy-beam machining process on a workpiece. The monitoring device includes a sensor assembly for measuring the process radiation occurring at the energy-beam machining process. The sensor assembly includes at least two optical sensors and is configured to resolve at least two sub-areas on the workpiece. The sensor assembly is configured to sample each of the sub-areas with a frequency fu of at least 1 kHz.

### CROSS-REFERENCE TO RELATED APPLICATIONS

The present application claims priority to German Patent Application No. 10 2025 117 605.1 filed May 8, 2025 and German Patent Application No. 10 2025 155 350.5 filed Dec. 30, 2025, the contents of which are herein incorporated by reference.

### TECHNICAL FIELD

The present disclosure relates to a monitoring device for monitoring an energy-beam machining process. Further, the disclosure relates to an energy-beam machining head for monitoring an energy-beam machining process. Further, the disclosure relates to a method of monitoring an energy-beam machining process.

### BACKGROUND

In an energy-beam machining system, also known as an energy-beam machining plant, for machining a workpiece, the energy-beam beam exiting from an energy-beam source or an end of an energy-beam guiding fiber is directed onto a workpiece to be machined with the help of beam-guiding and focusing optics. The workpiece may, in particular, be a metallic workpiece. The machining may comprise energy-beam welding or energy-beam cutting. Many other ways of energy-beam machining are possible. The energy-beam machining system may comprise an energy-beam machining head, such as an energy-beam welding head or an energy-beam cutting head, in which the optics are arranged. The energy-beam machining process may, for example, comprise an energy-beam welding process and an energy-beam cutting process.

In order to ensure the machining quality, it is important to continuously monitor the energy-beam machining process. Monitoring occurs typically by sensing and evaluating optical process emissions emerging during the energy-beam machining process. The optical process emissions comprise the energy-beam radiation backscattered or reflected by the workpiece (so-called laser back reflection), radiation in the (near-)infrared wavelength range of the light (so-called infrared wavelength range), e.g., thermal radiation, and radiation in the visible wavelength range of light, e.g., radiation from a plasma emerging during machining. The optical process emissions may may be referred to as process radiation or process beam.

The process radiation is typically sensed by photodiodes. The photodiodes may be part of a monitoring device arranged on the energy-beam machining head. The process radiation may be coupled into the monitoring device through the energy-beam machining head. In the monitoring device, the process radiation is split into partial beams, each with different wavelength ranges, by a beam splitter assembly with one or more beam splitters with a wavelength-selective coating or by optical filters. The photodiodes each sense an intensity of a corresponding partial beam with the predetermined wavelength range and generate a corresponding sensor signal. The sensor signal corresponds to the (average) intensity of the respective wavelength range. Changes in the measured intensity in relation to reference data are an indicator for errors that occurred in the conducted energy-beam machining process. For monitoring, the sensor signal progressions are, for example, compared to respectively predetermined envelopes and/or thresholds, and an error is output when a sensor signal is outside the envelopes or goes above or below a threshold. The error detection may be optimized by simultaneously considering different wavelength ranges.

In energy-beam machining processes, different areas on or at the workpiece that are of interest in monitoring may be defined. Here, for example in energy-beam welding, different sub-areas of the machining area are of particular interest. The machining area encompasses the point where the energy-beam beam impinges on the workpiece. At this point, the so-called keyhole (also known as a vapor capillary) is formed, which typically corresponds to or encompasses the "Tool Center Point" (short "TCP") of the energy-beam machining system. The machining area may be further considered to comprise a melt pool surrounding the keyhole, in which the material of the workpiece is melted. Also of interest are areas in the vicinity of the melt pool, for example, areas upstream and/or downstream of the melt pool or keyhole, respectively, and/or areas lateral or adjacent, respectively, to the melt pool or keyhole, respectively. The process radiation radiated from the mentioned areas reacts in different ways to changes and/or errors in the energy-beam machining process. For example, a changed heat distribution in a top plate may be seen in energy-beam welding processes with a gap between upper and lower sheets compared to energy-beam welding processes without a gap.

### SUMMARY

In monitoring the energy-beam machining process, particularly a laser machining process, by a sensor with a single photodiode, this information is partially lost, as all signals from the sensed area of the workpiece surface are detected in sum, and thereby, no spatially separate evaluation is possible. In as much, each photodiode integrates the sensed intensity over all wavelengths in its specific spectral sensitivity range. Thus, photodiodes offer no spatial resolution (resolution of location).

On the one hand, camera-based monitoring devices allow for precise, spatially resolved imaging of the energy-beam machining process, in particular, of the laser machining process or the workpiece surface, respectively. On the other hand, the high spatial resolution comes at the expense of data acquisition rate or readout frequency, respectively. Minor errors and/or microdefects, particularly those with error sources with a short duration or a short time scale, are not detected in this course. This limits error detection. Furthermore, each sensor integrates the intensity over the sensor’s entire wavelength range. There is no spectral resolution. Additionally, camera-based monitoring requires corresponding resources for sensing or capturing, respectively, processing, and storing very large amounts of data.

It is an object of the present disclosure to improve a monitoring of an energy-beam machining process, particularly a laser machining process. It is another object the present disclosure to improve an error detection at an energy-beam machining process, particularly a laser machining process.

At least one of the objects is solved by the present disclosure.

Disclosed is a monitoring device for monitoring an energy-beam machining process, particularly a laser machining process, on a workpiece. The monitoring device comprises a sensor assembly for measuring the process radiation occurring at the energy-beam machining process. The sensor assembly comprises at least two optical sensors. The sensor assembly is configured to resolve at least two sub-areas on the workpiece. The sensor assembly is configured to sample each of the sub-areas with a frequency fu of at least 1 kHz.

Further disclosed is an energy-beam machining head for radiating an energy beam onto a workpiece, particularly a laser machining head for radiating a laser beam onto a workpiece. The energy-beam machining head comprises a monitoring device disclosed herein.

Further disclosed is a method of monitoring an energy-beam machining process, particularly a laser machining process, by a monitoring device. The method comprises the steps: radiating an energy beam onto a workpiece such that the workpiece is being heated and process radiation occurs, and measuring, by a sensor assembly of the monitoring device, the process radiation emanating from the workpiece. By the sensor assembly, at least two sub-areas on the workpiece are resolved. Each of the sub-areas is sampled with a frequency of at least 1 kHz.

Each monitoring device disclosed herein may be employed in each energy-beam machining head and/or method disclosed herein.

Each energy-beam machining head disclosed herein may be employed in each method disclosed herein.

Each method disclosed herein may be executed by each energy-beam machining head and/or monitoring device disclosed herein. Particularly, the energy-beam machining head and/or the monitoring device may comprise a controller (or a control device) configured to execute the method steps. The controller may be configured to execute each method step disclosed herein.

As described also in beginning, at energy-beam machining processes, different spatial process areas may be defined, e.g., at energy-beam deep welding: the so-called keyhole around the machining point, and outer areas such as upstream and downstream of the weld or lateral edge areas of the melt pool. In this course, light emitted/reflected from different process areas reacts differently to process changes/errors. For example, a changed heat distribution in the upper sheet may be detected at welding processes with a gap between the upper and lower sheets compared to processes without a gap. In a sensor with single photodiodes, this information may be partially lost, as all signals from the imaging area are detected in sum and, thereby, no spatially separate evaluation is possible.

On the one hand, camera-based sensor systems offer a very precise spatially resolved imaging of the energy-beam machining process, on the other hand, the high spatial resolution comes at the expense of the data acquisition rate. In this course, welding errors that occur on a short time scale are not recognized. Furthermore, a typical imaging concept also requires corresponding resources for capturing and processing very large amounts of data.

The present disclosure provides an optimum or an optimal range, respectively, between spatially resolved monitoring with a sufficiently high sampling frequency.

The energy-beam machining process may be an energy-beam printing process, energy-beam ablation process, energy-beam soldering process, energy-beam application welding process (additive manufacturing), energy-beam welding process or an energy-beam cutting process. The workpiece may be a metallic workpiece, particularly sheet metal.

In general, the energy beam may be a laser or a laser beam, respectively, an electron beam, an ion beam, a plasma beam, an arc, a UV beam, an IR beam, a micro-wave beam, a Gamma beam, a proton beam, or a neutron beam. In embodiments, the energy beam is a laser.

The term or term component, respectively, "energy beam" herein may be replaced by: laser, laser beam, electron beam, ion beam, plasma beam, arc, UV beam, IR beam, micro-wave beam, Gamma beam, proton beam, or neutron beam. In embodiments, the term or term component, respectively, "energy beam" herein may be replaced by laser or laser beam, respectively.

The energy-beam machining process may be a laser machining process, a laser cutting, a laser drilling, a laser ablating, a laser tagging, a laser engraving, a laser welding, a laser soldering, a laser surface modification, a laser hardening, a laser alloy, a laser polishing, a laser cleaning, an electron-beam welding (EBW), an electron-beam drilling, an electron-beam ablating, an electron-beam hardening, an ion-beam cutting, an ion-beam ablating, an ion-beam etching (IBE), a plasma cutting, a plasma spraying, a plasma hardening, an arc welding, a UV lithography, an IR heating, an IR shrinking, an IR drying, a UV hardening, a micro-wave drying, a micro-wave heating, or a micro-wave sintering.

In radiating or due to the radiating the energy beam, respectively, process emission occurs, for example by warming the workpiece. The process emission may comprise radiation in the wavelength range visible to humans, that is between 350 nm and 850 nm, or between 390 nm and 850 nm, or between 380 nm and 800 nm, e.g., radiation of plasma emerging during machining. The process emission may comprise radiation in the infrared wavelength range, particularly thermal radiation.

Additionally, radiation of the energy beam may be backscattered or reflected from the workpiece.

The process radiation may comprise the radiation emitted by the workpiece (process emission) and/or the energy-beam radiation backscattered or reflected from the workpiece (back-reflection). In embodiments, the process radiation comprises the wavelength range "near infrared" (NIR). In embodiments, the NIR wavelength range may be between 780 nm and 3000 nm or between 780 nm and 1400 nm. The sensor assembly or the sensors of the sensor assembly may, respectively, be sensitive at least for a sub-area of the NIR wavelength range. In embodiments, the process radiation comprises a wavelength range between 650 nm and 1650 nm. The sensor assembly or the sensors of the sensor assembly may, respectively, be sensitive at least for this wavelength range (650 nm and 1650 nm). The sensor assembly or the sensors of the sensor assembly may, respectively, be sensitive for one and/or a plurality of sub-areas in the wavelength range of 650 nm to 1650 nm or fully comprise this wavelength range.

The at least two sub-areas on the workpiece may be immediately adjacent to each other. Alternatively, there may be a distance between the at least two sub-areas.

In embodiments, the at least two sub-areas comprise the keyhole (also denoted as machining point) and/or the melt pool and/or the melted but already solidified weld overrun on the workpiece. At least one of the sub-areas may be directed to the keyhole and/or the melt pool and/or the melted but already solidified weld overrun on the workpiece. Alternatively or additionally, at least one of the sub-areas may be directed to an edge area of the keyhole and/or to an edge area of the melt pool and/or to an edge area of the melted but already solidified weld overruns.

Each of the sub-areas is sampled with a frequency fu of at least 1 kHz. Therefore, at least 1000 data points per second are generated per sub-area.

The sensor assembly may be configured to sample each of the sub-areas (on the workpiece) with a frequency of at least 5 kHz. In embodiments, the sensor assembly is configured to sample each of the sub-areas (on the workpiece) with a frequency of at least 10 kHz, at least 15 kHz, at least 20 kHz, at least 25 kHz, at least 30 kHz, at least 35 kHz, at least 40 kHz, at least 45 kHz, at least 50 kHz, at least 100 kHz, at least 150 kHz, at least 200 kHz, or at least 250 kHz.

Through the high sampling frequency of the sub-areas on the workpiece, process deviations on a smaller time scale may be monitored and considered.

The sensor assembly may be configured to sample each of the sub-areas with a frequency fu of fu = f0/u. Thereby, u is the number of the sub-areas and f0 is the overall frequency. In embodiments, the overall frequency f0 may be at least 10 kHz, at least 50 kHz, at least 100 kHz, at least 250 kHz, at least 500 kHz, at least 750 kHz, at least 1000 kHz, or at least 1250 kHz. In particular, the number of the sub-areas u is the number of the selected sub-areas. Selected sub-areas may be the sub-areas considered or activated, respectively, at one point in time. Along with the selected sub-areas, there may be other (currently) not selected sub-areas.

In a case where few sub-areas are considered, the sampling frequency per sub-area may increase and monitoring the energy-beam machining process may be improved.

The sensor assembly may be configured to (spatially) resolve at least 4 (four) sub-areas on the workpiece. In embodiments, the sensor assembly is configured to resolve at least 9 sub-areas, at least 16 sub-areas, at least 25 sub-areas, at least 36 sub-areas, or at least 49 sub-areas on the workpiece.

The sensor assembly may be configured to (spatially) resolve at most 121 sub-areas on the workpiece. In embodiments, the sensor assembly is configured to resolve at most 100 sub-areas, at most 81 sub-areas, at most 64 sub-areas, at most 49 sub-areas, at most 36 sub-areas, or at most 25 sub-areas on the workpiece.

In embodiments, the sensor assembly may be configured to resolve between 2 sub-areas and 121 sub-areas, between 2 sub-areas and 100 sub-areas, between 4 sub-areas and 81 sub-areas, between 4 sub-areas and 64 sub-areas, between 9 sub-areas and 49 sub-areas, or between 16 sub-areas and 36 sub-areas on the workpiece.

The sensor assembly may be configured to resolve exactly 2 sub-areas, exactly 4 sub-areas, exactly 9 sub-areas, exactly 16 sub-areas, exactly 19 sub-areas, exactly 25 sub-areas, exactly 36 sub-areas, exactly 49 sub-areas, exactly 64 sub-areas, exactly 81 sub-areas or exact 100 sub-areas on the workpiece.

In embodiments, the sensor assembly is configured to resolve exactly 25 sub-areas on the workpiece.

Each of the sub-areas may be resolvable into different wavelength ranges.

The sub-areas may be fully separate sub-areas. The sub-areas may be non-overlapping. None of the sub-areas may overlap another one of the sub-areas. The sub-areas may be understood as an area.

The sub-areas may be provided in regular or irregular grids on the workpiece. In embodiments, the sub-areas are provided in a regular grid on the workpiece. Particularly, the number of sub-areas per row is identical to the number of sub-areas per column.

At least some or all of the sub-areas may be provided annularly on the workpiece.

At least some or all of the sub-areas may be provided as sections of a circle or annulus on the workpiece.

An area on the workpiece may be imaged to the sensor assembly. The area may comprise the sub-areas. In embodiments, the area comprises all sub-areas. To do so, radiation, e.g., radiation emitted from the workpiece and/or energy radiation reflected by the workpiece, may be directed towards the sensor assembly. In the energy-beam machining head, the radiation and the machining-energy beam may overlay each other in sections.

The energy-beam machining head may comprise a beam splitter arranged in the optical path of the machining-energy beam. Through the beam splitter, the radiation emanating from the workpiece, i.e., the process radiation, may be coupled out to the sensor assembly.

Between the beam splitter and the sensor assembly, at least one optical element may be arranged. The optical element may be configured to focus the process radiation on the sensor assembly.

The sensor assembly may comprise at least 2 (two) optical sensors. The sensor assembly may comprise at least 4 (four) sensors. In embodiments, the sensor assembly comprises at least 9 sensors, at least 16 sensors, at least 25 sensors, at least 36 sensors, or at least 49 sensors.

The sensor assembly may comprise at most 121 sensors. In embodiments, the sensor assembly comprises at most 100 sensors, at most 81 sensors, at most 64 sensors, at most 49 sensors, at most 36 sensors, or at most 25 sensors.

In embodiments, the sensor assembly may comprise between 2 sensors and 121 sensors, between 2 sensors and 100 sensors, between 4 sensors and 81 sensors, between 4 sensors and 64 sensors, between 9 sensors and 49 sensors, or between 16 sensors and 36 sensors.

The sensor assembly may comprise exactly 2 sensors, exactly 4 sensors, exactly 9 sensors, exactly 16 sensors, exactly 19 sensors, exactly 25 sensors, exactly 36 sensors, exactly 49 sensors, exactly 64 sensors, exactly 81 sensors, or exactly 100 sensors. In embodiments, the sensor assembly comprises exactly 25 sensors.

In embodiments, the number of sensors comprised by the sensor assembly and/or the number of sub-areas resolved on the workpiece is odd.

In embodiments, the number of sensors comprised by the sensor assembly and the number of sub-areas resolved on the workpiece are identical. In other words, the sensor assembly may comprise (exactly) one optical sensor per sub-area on the workpiece.

The optical sensors may be photodiodes. The optical sensors may have optical silicon sensors (e.g., silicon photodiodes). The optical sensors may be optical silicon sensors.

The silicon sensors may have a wavelength sensitivity range of about 190 nm to 1100 nm. In embodiments, the wavelength sensitivity range is between 600 nm and 900 nm.

The optical sensors may have or be silicon photodiodes.

The optical sensors may have optical compound-semiconductor sensors (e.g., compound-semiconductor photodiodes). The optical sensors may be optical compound-semiconductor sensors.

A compound-semiconductor sensor may comprise at least one compound-semiconductor material employed for acquiring the process radiation. The compound-semiconductor material may comprise at least two different elements or at least three different elements. The compound-semiconductor material may be a binary or a ternary material. The optical compound-semiconductor sensors may be III-V compound-semiconductor sensors or II-VI compound-semiconductor sensors.

The semiconductor material of the optical sensors may have In (indium). The semiconductor material of the optical sensors may have Ga (gallium). The semiconductor material of the optical sensors may have As (Arsen). In embodiments, the semiconductor material comprises In, Ga, and As. The optical sensors may be InGaAs sensors.

The compound-semiconductor sensors may have a wavelength sensitivity range of about 500 nm to 2600 nm. In embodiments, the wavelength sensitivity range is between 1200 nm and 1700 nm.

In embodiments, the photodiodes are part of a photodiode array.

Each of the optical sensors may be individually readable, individually drivable, individually amplifiable, individually selectable, individually switchable on and off, and/or individually evaluable. Alternatively or additionally, a respective measurement signal of the optical sensors may be individually readable, individually drivable, individually amplifiable, individually selectable, individually switchable on and off, and/or individually evaluable.

Each of the optical sensors may have at least one separate electric line. Each of the optical sensors may have a separate cathode. Each of the optical sensors may have a separate cathode and all optical sensors may have a common anode. Each of the optical sensors may have a separate anode. Each of the optical sensors may have a separate anode and all optical sensors may have a common cathode. Each of the optical sensors may have a separate cathode and separate anode.

Through the at least one separate electric line, each of the optical sensors and/or their measurement signal may be individually readable, individually drivable, individually amplifiable, individually selectable, individually switchable on and off, and/or individually evaluable.

In embodiments, at least one, a plurality, or each of the optical sensors is connected to a controller (also referred to as control device). The controller may be configured to individually read out, to individually drive, to individually amplify, to individually select, to individually turn on and off, and/or to individually evaluate at least one, a plurality, or each of the optical sensors.

At least one, a plurality, or each of the optical sensors may be separately or individually selectable and/or (de)activatable, respectively. For example, the area considered on the workpiece may initially be inspected by all optical sensors. Based on the measurement with all optical sensors, some of the sensors may be deactivated or suppressed for subsequent measurements. Thereby, the generated amount of data may be reduced or the Measurement frequency may be increased, without significantly increasing the amount of data.

The sensor assembly may measure the process radiation emanating from the workpiece with all or a major portion of the sub-areas resolved by the sensor assembly. A subset of the sub-areas may be selected by a user, for example. The sensor assembly may measure the process radiation emanating from the workpiece (only or exclusively or exactly) with the selected sub-areas.

A central sub-area or a central sensor, respectively, may be directed to the keyhole and surrounding sub-areas or sensors, respectively, may be directed to the environment of the keyhole. In this course, a considerable intensity difference for the sub-areas may reveal itself. This may, for example, overcharge the dynamic range of cameras. Through the individual adjustability (amplification) of the individual sensors, the sensor assembly may be adapted to different measurement tasks (automatically or manually) and the sensor assembly (the entirety of all individual sensors) has an effectively extended dynamic range.

The number of the resolved sub-areas on the workpiece may be adjustable. The controller may be configured to set the number of the resolved sub-areas on the workpiece. Setting the number of the sub-areas may occur by activating or deactivating, respectively, optical sensors of the sensor assembly. As described above, a sub-area on the workpiece may be associated with each optical sensor of the sensor assembly. In a case where some of the sensors are not activated or not read out, respectively, the number of the considered sub-areas on the workpiece may be reduced. By limiting the number of read out/evaluated sub-areas/sensors to "relevant" areas, the sampling frequency of the read out/evaluated sub-areas/sensors may be increased and/or the amount of data may be reduced.

At least some of the optical sensors, and in embodiments, all of the optical sensors may comprise an optical filter, and in embodiments comprise a common optical filter. The optical filter may be adjustable or replaceable. That is, the optical filtering of the sensors or the wavelength sensitivity range of the sensors, respectively, may be variable.

In embodiments, the optical sensors are sensitive over a wavelength range of at most 300 nm, at most 200 nm, or at most 100 nm. In the wavelength range visible to humans, the optical sensors may be sensitive over a wavelength range of at most 100 nm. In the NIR wavelength range, the optical sensors may be sensitive over a wavelength range of at most 200 nm. The wavelength range may be adjustable by the optical filter.

The monitoring device may comprise a varifocal lens and/or a zoom lens. The varifocal lens and/or a zoom lens may be electrically adjustable. By the varifocal lens and/or the zoom lens, the area monitored on the workpiece may be enlarged or reduced. The process radiation may pass the varifocal lens and/or the zoom lens before the process radiation is measured by the sensor assembly. Thereby, the area monitored on the workpiece with the at least two sub-areas may be adapted to different energy-beam machining processes.

The monitoring device may comprise a controller. The controller may also be referred to as control device. The controller may also be in the energy-beam machining head. The controller may be configured to evaluate measurement data of the sensor assembly. Particularly, the sensor assembly is configured to monitor and/or to control or to regulate, respectively, the energy-beam machining process based on the measurement data.

The controller may be configured to receive measurement signals from the sensor assembly. The measurement signals may be generated by measuring the process radiation. Per optical sensor or per sub-area, respectively, the controller may receive a separate measurement signal. The controller may be configured, to control and/or read out the optical sensors (one at a time or separately or individually). The controller may be configured to evaluate the measurement signals. Based on the evaluation of the measurement signals, the controller may be configured to control or to regulate the energy-beam machining process. Alternatively or additionally, the controller may be configured, to determine, based on the evaluation of the measurement signals, whether the energy-beam machining process is running or has run incorrectly or correctly.

The controller may be configured to evaluate the measurement signals generated by the sensor assembly or, respectively, the measurement signals generated the optical sensors. The measurement signals are generated by measuring the process radiation or measuring an intensity of the process radiation, respectively.

For evaluation, a 1D or 2D intensity profile may be created. A 1D intensity profile may be an intensity distribution along a line on the surface of the workpiece. A 2D intensity profile may be an intensity distribution over an area on the surface of the workpiece. The intensity profile may be created based on measurement values or measurement signals, respectively, of the sensor assembly in the area on the workpiece with the at least two sub-areas.

In the intensity profile, a height of one or more peaks, the position of one or more peaks, the width of one or more peaks, the skew of one or more peaks, and/or the curvature of one or more peaks may be evaluated. Based on this evaluation, the energy-beam machining process may be controlled or regulated. Alternatively or additionally, whether the energy-beam machining process is running or has run incorrectly or correctly, may be determined based on this evaluation.

The curvature of the one or more peaks may be a measure for the steepness or "pointedness", respectively. The curvature may also be denoted as "kurtosis". The skew of the one or more peaks may describe the type and the strength of an asymmetry.

The controller may be configured to evaluate the measurement data with the help of a neuronal network and/or artificial intelligence model and/or machine learning model.

The controller may be configured to process the read-out sensor data or measurement signals, respectively, of the optical sensors as raw data and/or without pre-processing by a transfer function, to obtain output data. The controller may be configured to monitor or regulate, respectively, the energy-beam machining process, based on the obtained output data. In other words, the read-out sensor data may be used (directly or immediately, respectively) as input data for the transfer function. The processing by the transfer function may take place continuously and/or in real time during the energy-beam machining process. The transfer function may be formed by a neuronal network and/or artificial intelligence model and/or machine learning model. The processing by a transfer function may also be denoted interference and/or may be performed by the neuronal processor.

The monitoring device may comprise an optical fiber for each of the optical sensors for directing process radiation from a respective sub-area on the workpiece to an associated optical sensor. The monitoring device may comprise an optical fiber bundle. The optical fiber bundle may comprise the optical fibers for the optical sensors.

A (monitored) area on the workpiece may be imaged to the sensor assembly. On the sensor assembly, first ends of optical fibers may be arranged. Second ends of optical fibers may each be connected to an optical sensor. The optical fibers may forward the process radiation to the optical sensors.

Per optical sensor or per sub-area, respectively, an optical fiber may be provided. The first ends of optical fibers may be arranged corresponding to the arrangement of sub-areas on the workpiece. The optical sensors must not be arranged in correspondence to the arrangement of sub-areas on the workpiece, when being connected to the optical fibers.

The energy-beam machining head may comprise a scanner device. The scanner device may be configured to deflect the energy beam onto a plurality of positions on the surface of the workpiece. The process radiation may pass the scanner device, before the process radiation of the sensor assembly is measured. In other words, the process radiation may be guided through the scanner device to the sensor assembly, or an optical path of the sensor assembly may extend through the scanner device, respectively.

The scanner device may comprise at least one scanning element, e.g., at least one scanning mirror tiltable or rotatable around one or two axes, to deflect the energy beam. In embodiments, the scanner device comprises at least two scanning elements, each tiltable or rotatable around one or two axes. The scanner device may be a galvo scanner device.

The optical sensors of the sensor assembly may be driven, read out, and/or activated or deactivated, respectively, dependent on the scanning field.

The monitoring device may be arranged on or in the energy-beam machining head such that a beam path of the sensor assembly extends coaxially with the beam path of the energy beam (machining-energy beam) at least in parts.

In embodiments, the monitoring device comprises no camera.

The monitoring device may comprise a beam splitter assembly. The beam splitter assembly may be configured, to couple out of the process radiation at least one first partial beam, so that there are at least one first and one second partial beam of process radiation. The monitoring device may comprise one (further) sensor assembly. The (further) sensor assembly may at most or exactly comprise one optical sensor, particularly exactly or at most one photodiode. The sensor assembly with the at most or exactly one optical sensor may be configured to measure the second partial beam of process radiation. The sensor assembly with the at least two optical sensors may be configured to measure the first partial beam of process radiation.

The monitoring device may also comprise at least two sensor assemblies. One of the sensor assemblies may comprise at least two optical sensors, to spatially resolve a partial beam of process radiation. The other sensor assembly may comprise only one optical sensor for measuring the other partial beam of process radiation.

The first partial beam and the second partial beam may comprise different wavelength ranges. The wavelength ranges may overlap, partially overlap, or be (fully) spaced apart from each other.

In embodiments, the first partial beam may comprise radiation in the wavelength range between 600 nm and 3000 nm, between 780 nm and 3000 nm, or 780 nm and 1400 nm. In embodiments, the first partial beam may comprise the wavelength range infrared, or "near infrared". Particularly, the first partial beam comprises substantially no radiation outside the respectively described wavelength range. For example, the first partial beam includes substantially no radiation outside the wavelength range between 600 nm and 3000 nm.

In embodiments, the first partial beam comprises radiation in the wavelength range between 600 nm and 900 nm, particularly between 650 nm and 900, between 600 nm and 850 nm, or between 650 nm and 850 nm. The sensor assembly may comprise silicon-based optical sensors.

The first partial beam may comprise radiation in the wavelength range between 1200 nm and 2800 nm. Particularly, the first partial beam may comprise radiation in the wavelength range between 1200 nm and 2200 nm, or between 1200 nm and 1600 nm. The sensor assembly may comprise InGaAs-based optical sensors.

As described above, the first partial beam may comprise substantially no radiation outside the respectively described wavelength range.

The beam splitter assembly may comprise a plurality of beam splitters. In embodiments, the beam splitter assembly may be configured to separate process radiation in at least two partial beams, at least three partial beams, at least four partial beams, at least five partial beams, at least six partial beams, or at least seven partial beams.

For example, the beam splitter assembly comprises at least two, at least three, at least four, at least five, or at least six beam splitters. Each of the beam splitters may couple out a partial beam or split a beam into two partial beams.

The monitoring device may comprise a second sensor assembly with at least two optical sensors. The second sensor assembly may be each sensor assembly disclosed herein. The second sensor assembly may be configured to resolve at least two sub-areas on the workpiece. In embodiments, the second sensor assembly with at least two optical sensors may be configured to measure a partial beam of process radiation comprising radiation in the wavelength range between 600 nm and 3000 nm, between 780 nm and 3000 nm (infrared, particularly "near infrared"), 780 nm and 1400 nm, or between 350 nm and 850 nm (visible light) or the wavelength of the energy beam (e.g., back-reflection of the energy beam, particularly back-reflection of the laser beam).

In embodiments, the wavelength range between 600 nm and 3000 nm is a wavelength range between 600 nm and 900 nm, particularly between 650 nm and 900, between 600 nm and 850 nm, or between 650 nm and 850 nm. The sensor assembly may comprise silicon-based sensors.

In embodiments, the wavelength range between 600 nm and 3000 nm is a wavelength range between 1200 nm and 2800 nm, between 1200 nm and 2200 nm, or between 1200 nm and 1600 nm. The sensor assembly may comprise InGaAs-based sensors.

As described above, the partial beam of process radiation, measured by the second sensor assembly with at least two optical sensors, may comprise substantially no radiation outside the respectively described wavelength range.

The monitoring device may also comprise a first sensor assembly with at least two optical sensors and a second sensor assembly with at least two optical sensors. The first sensor assembly may measure a partial beam of process radiation comprising radiation in the wavelength range between 300 nm and 3000 nm. In embodiments, the second sensor assembly may measure a partial beam of process radiation comprising radiation in the wavelength range between 780 nm and 3000 nm, between 780 nm and 1400 nm, between 350 nm and 850 nm, between 350 nm and 779 nm, or the wavelength of the energy beam.

In addition to the first sensor assembly and the second sensor assembly with at least two optical sensors each, the monitoring device may comprise a sensor assembly with exactly or at most one optical sensor.

In embodiments, the monitoring device may comprise at least two, at least three, at least four, or at least five sensor assemblies with at most or exactly one optical sensor, particularly a photodiode.

The sensor assemblies with at most or exactly one optical sensor may measure partial beams of the process radiation with different wavelength ranges.

The monitoring device may comprise the first sensor assembly with at least two optical sensors. Additionally, the monitoring device may comprise at least one, at least two, at least three, at least four, or at least five sensor assemblies with exactly or at most one optical sensor. Each of the sensor assemblies may measure a (different) partial beam of process radiation.

The monitoring device may comprise the first sensor assembly with at least two optical sensors and the second sensor assembly with at least two optical sensors. Additionally, the monitoring device may comprise at least one, at least two, at least three, at least four, or at least five sensor assemblies with exactly or at most one optical sensor. Each of the sensor assemblies may measure a (different) partial beam of process radiation.

Generally, the exactly or at most one optical sensor may be a photodiode.

The monitoring device may comprise: a beam splitter assembly, configured to couple out from the process radiation at least two visible partial beams, each with one of at least two different visible wavelength ranges and at least one infrared partial beam with an infrared wavelength range; a first acquisition assembly for sensing the intensity of the process radiation in the visible wavelength range with at least two sensor assemblies arranged to each sense an intensity of one of the visible partial beams; and a second acquisition assembly for sensing the intensity of the process radiation in the infrared wavelength range with at least one sensor assembly arranged to sense an intensity of the infrared partial beam.

Each sensor assembly may be each sensor assembly disclosed herein. Particularly, at least one of the sensor assemblies is a sensor assembly with at least two optical sensors. The other sensor assembly may be a sensor assembly with at most or exactly one optical sensor.

The monitoring device may comprise a beam splitter assembly configured to couple out from the process radiation a plurality of visible partial beams with a respective visible wavelength range; a first acquisition assembly for sensing the intensity of the process radiation in the visible wavelength range with a plurality of sensor assemblies arranged to each sense an intensity of one of the visible partial beams, the beam splitter assembly configured to couple out a first visible partial beam with a first visible wavelength range, a second visible partial beam with a second visible wavelength range, a third visible partial beam with a third visible wavelength range, and a fourth visible partial beam with a fourth visible wavelength range to a sensor assembly of the first acquisition assembly, respectively, and the first acquisition assembly comprising: a first sensor assembly arranged to sense an intensity of the first visible partial beam, a second sensor assembly arranged to sense an intensity of the second visible partial beam, a third sensor assembly arranged to sense an intensity of the third visible partial beam, and a fourth sensor assembly arranged to sense an intensity of the fourth visible partial beam.

Each sensor assembly may be each sensor assembly disclosed herein. Particularly, at least one of the sensor assemblies is a sensor assembly with at least two optical sensors. Another sensor assembly may be a sensor assembly with at most or exactly one optical sensor.

The monitoring device may comprise a third acquisition assembly for sensing the intensity of the process beam in the back-reflection wavelength range. The third acquisition assembly may comprise a sensor assembly arranged to sense an intensity of the back-reflection partial beam.

The sensor assembly may be each sensor assembly disclosed herein. Particularly, the sensor assembly is a sensor assembly with at least two optical sensors or a sensor assembly with at most or exactly one optical sensor.

A "monitored wavelength range" may a wavelength range of the process beam (herein, "process beam" is used synonymously to "process radiation") sensed by a sensor assembly for monitoring the energy beam process or the laser machining process, respectively. Particularly, the intensity of the process beam is sensed in this wavelength range, and a corresponding sensor signal is generated. The sensor signal may subsequently be evaluated and/or recorded. The "visible wavelength range" may denote a wavelength range primarily comprising wavelengths in the visible spectrum of light. Particularly, the visible wavelength range may be or comprise a wavelength range between 350 nm and 850 nm, or between 390 nm and 850 nm, or between 380 nm and 800 nm. The "infrared wavelength range" particularly denotes a wavelength range primarily comprising wavelengths in the infrared spectral range. However, the wavelength range is not limited to wavelengths in the infrared spectral range, as thermal radiation, i.e., thermal emission of light, may also occur in other spectral ranges, e.g., ultraviolet and visible. Particularly, the infrared wavelength range may be or comprise a wavelength range between 1200 nm and 2100 nm. Further, "visible partial beam" denotes a partial beam in the visible wavelength range, "infrared partial beam" denotes a partial beam in the infrared wavelength range, and "back-reflection partial beam" denotes a partial beam in the back-reflection wavelength range. "Non overlapping" wave ranges means that no wavelength of the one wavelength range is included in the respective other wavelength range. "Non overlapping" is synonymous to "fully different from each other."

"Coupling out a partial beam" by a beam splitter assembly means that the process beam is split by the beam splitter assembly at least once in two partial beams, namely this partial beam and another partial beam. The partial beam coupled out may have been reflected at least once and/or transmitted at least once by the beam splitter assembly. To do so, the beam splitter assembly may comprise at least one beam splitter. The split to two partial beams is not limited to 45° between a beam splitter and the incident beam (the process beam or a partial beam of the process beam), rather, arbitrary angles are possible. The split into two partial beams may take place with a neutral and/or non-selective beam splitter (e.g., at a ratio of 50:50 or 90:10), or selectively by a light property (e.g., by the wavelength and/or the polarization). A partial beam having "passed" a beam splitter comprises that a part of a beam (the process beam or a partial beam of the process beam) is reflected as this partial beam by the beam splitter or is transmitted as this partial beam by the beam splitter.

The beam splitter assembly may comprise a plurality of beam splitters. On the path from entry into the monitoring device to the sensor assemblies, the light of the process beam interacts with the beam splitters. A primary beam splitter may be defined as the first beam splitter in the beam path of the process beam after entry into the monitoring device. In this course, the process beam is split into (exactly) two partial beams, a reflected partial beam and transmitted a partial beam. The beam splitters in the beam path of these partial beams are denoted secondary beam splitters, etc. With each further interaction (reflection/transmission) of one of the partial beams with a further beam splitter of the beam splitter assembly, the order of the respective beam splitter (beam splitter order) increases: tertiary, quaternary, quinternary, sextiary, septimary, etc. In a beam splitter assembly, there may also be (a maximum of) one primary beam splitter, two secondary beam splitters, four tertiary beam splitters, eight quaternary beam splitters, 16 quinternary beam splitters, etc. Conversely, the "primary beam splitter order" means the primary beam splitter of the beam splitter assembly, the "secondary beam splitter order" the secondary beam splitter of the beam splitter assembly, etc.

Thereby, the wavelength range of the process beam, particularly of the visible wavelength range, may be split into smaller narrow-band wavelength ranges and the intensity of the process beam for each of the narrow-band wavelength ranges may be sensed individually. To do so, the beam splitter assembly provides for a corresponding partial beam to be coupled out from the process beam for each of the narrow-band wavelength ranges and be steered or directed, respectively, to a corresponding sensor assembly. The intensity of each partial beam is sensed by the corresponding sensor assembly, able to output a sensor signal corresponding to the sensed intensity.

In embodiments, thereby, monitoring the energy beam process or the laser machining process, respectively, may be enabled based on three or more, four, at least seven wavelength ranges, and particularly based on at least two, three, or four visible wavelength ranges. This permits more precise monitoring, because certain process defects may be recognized actually or better.

Moreover, sensing and/or processing and/or evaluating of each wavelength range may take place separately from the others and thus individually. The sensor signals of the different wavelength ranges may, for example, be amplified separately and/or differently from each other. Thus, each generated sensor signal may be subjected to an individual amplification. Individual amplification is important, because the intensities of the partial beams frequently vary by multiple orders of magnitude. For example, the energy-beam back reflection, particularly the laser back reflection, usually has a very high intensity, while the intensity of the infrared radiation, compared to it, is typically smaller by orders of magnitude. The disclosure permits individual amplification of the sensor signals of the different wavelength ranges in a wide range of orders of magnitude, for example by a factor 10 to 10⁷.

In another example, the optical imaging may be individually adapted and set for each partial beam or for each wavelength range, respectively. To do so, the beam splitter assembly may be configured to couple out each of the plurality of partial beams with a predetermined optical imaging and/or an individually adjustable optical imaging to the corresponding sensor assembly. The beam splitter assembly may comprise an imaging device. The imaging device may comprise an aperture for each partial beam. The aperture opening of each of the apertures may be individually adjustable. The apertures may be inverse apertures. The apertures may be configured for optomechanical beam guidance and/or obstruction. Further, the imaging device may comprise, for each partial beam, at least one optical element, e.g., a lens or a lens system for setting the imaging of the partial beam to the sensor area of the corresponding sensor assembly. Thus, the beam splitter assembly may be used for spatial optical filtering, beam guidance, or beam obstruction, respectively.

Alternatively or additionally, for each partial beam or wavelength range, respectively, a size of the sensor area of the corresponding sensor assembly and/or position of the sensor area along the beam axis may be selected or adjustable independently and/or differently from other partial beams or wavelength ranges, respectively. Thus, a cutout of the process area, from which the intensity of the partial beam or of the monitored wavelength range, respectively, are sensed, may be set individually.

Thereby, the images of the individual wavelength ranges may be set spatially optimized. So to speak, the individual wavelength ranges may be spatially filtered. For each partial beam or each monitored wavelength range, respectively, an optimized image on the corresponding sensor assembly may be selected or set, respectively.

The monitoring device may comprise an optical input for letting in the process beam.

The beam splitter assembly may be configured, to couple out from the process beam a plurality of partial beams with respectively different wavelength ranges. Here, the wavelength ranges of the partial beams coupled out by the beam splitter assembly may be fully different from each other, i.e., not overlap each other. The wavelength ranges of the partial beams coupled out by the beam splitter assembly may have a width between 50 nm and 200 nm or between 50 and 100 nm.

The beam splitter assembly may be configured to couple out, from the process beam, a back-reflection partial beam with the back-reflection wavelength range.

In embodiments, the back-reflection wavelength range may comprise the wavelength of the energy radiation, particularly of the laser beam, and/or a wavelength range of 950 nm to 1150 nm, 1000 nm to 1100 nm, or comprise a wavelength range in the green spectral range or in the blue spectral range. The beam splitter assembly may be configured to guide the back-reflection partial beam to the sensor assembly of the third acquisition assembly. The energy beam, particularly the laser beam, may comprise a wavelength in the infrared or visible, particularly green or blue, spectral range.

The visible wavelength range and the infrared wavelength range or the visible wavelength range, the infrared wavelength range, and the back-reflection wavelength range, respectively, may be fully different from each other, i.e., not overlap each other.

The first acquisition assembly may comprise a plurality of sensor assemblies for sensing the intensity of the process beam in the visible wavelength range. The first acquisition assembly may comprise, for each visible partial beam coupled out by the beam splitter assembly from the process beam, a sensor assembly, to sense the intensities of the plurality of visible partial beams separately from each other.

The second acquisition assembly may comprise a plurality of sensor assemblies for sensing the intensity of the process beam in the infrared wavelength range. The second acquisition assembly may comprise, for each infrared partial beam coupled out by the beam splitter assembly from the process beam, a sensor assembly, to sense the intensities of the plurality of temperature partial beams separately from each other.

The beam splitter assembly may each be configured to couple out a first visible partial beam with a first visible wavelength range and a second visible partial beam with a second visible wavelength range to a respective sensor assembly of the first acquisition assembly. The beam splitter assembly may further be configured to couple out a third visible partial beam with a third visible wavelength range to a third sensor assembly of the first acquisition assembly. The beam splitter assembly may further be configured to couple out a fourth visible partial beam with a fourth visible wavelength range to a fourth sensor assembly of the first acquisition assembly.

The first acquisition assembly may comprise a first sensor assembly arranged to sense an intensity of the first visible partial beam, and a second sensor assembly arranged to sense an intensity of the second visible partial beam. The first acquisition assembly may further comprise a third sensor assembly arranged to sense an intensity of the third visible partial beam. The first acquisition assembly may further comprise a fourth sensor assembly arranged to sense an intensity of the fourth visible partial beam.

One of the visible wavelength ranges may be fully included in at least one further visible wavelength range. The visible wavelength ranges may be identical. The visible wavelength ranges may be imaged differently on corresponding sensor assemblies.

The plurality of visible wavelength ranges may be different from each other and/or may not overlap each other. If existing, the first, second, third, and/or fourth visible wavelength ranges may be fully different from each other, i.e., not overlap each other. The first visible wavelength range, the second visible wavelength range, the third visible wavelength range, and the fourth visible wavelength range may be different from each other and/or not overlapping each other and/or adjacent to each other in this order. Particularly, the first visible wavelength range and the second visible wavelength range may be adjacent to each other, and/or the second visible wavelength range and the third visible wavelength range may be adjacent to each other, and/or the third visible wavelength range and the fourth visible wavelength range may be adjacent to each other. By separately sensing the intensity in a plurality of visible wavelength ranges, effects, operations and errors of the energy beam process or the laser machining process, respectively, that were so far not taken into account and/or not apparent, may be sensed and monitored.

The different wavelength ranges of the visible partial beams may be selected from: 350 nm to 450 nm, 450 nm to 550 nm, 550 nm to 650 nm and 650 nm to 850 nm. The plurality of visible wavelength ranges, particularly the first, second, third, and/or fourth visible wavelength ranges, may each contain at least one wavelength selected from: 400 nm, 500 nm, 600 nm, 700 nm, 750 nm, 800 nm, a wavelength of a component of a workpiece machined by the energy-beam machining process, particularly a steel alloy or components of a steel alloy or an aluminum alloy or components of an aluminum alloy, a wavelength of an emission band of aluminum oxide, a wavelength of an emission band of iron oxide, and a wavelength of an atomic emission line, particularly of titanium, copper, aluminum, or iron. The first visible wavelength range may comprise 400 nm, and/or the second visible wavelength range may comprise 500 nm, and/or the third visible wavelength range may comprise 600 nm, and/or the fourth wavelength range may comprise 750 nm.

The beam splitter assembly may further be configured to couple out at least one infrared partial beam with an infrared wavelength range from the process beam. The monitoring device may further comprise: a second acquisition assembly for sensing the intensity of the process beam in the infrared wavelength range with at least one sensor assembly arranged to sense an intensity of the infrared partial beam.

The beam splitter assembly may be configured to couple out each of a first infrared partial beam with a first infrared wavelength range, and a second infrared partial beam with a second infrared wavelength range to a respective sensor assembly of the second acquisition assembly. The second acquisition assembly may be configured for sensing an intensity of the process beam in the first infrared wavelength range and in the second infrared wavelength range. The second acquisition assembly may comprise at least two sensor assemblies. The second acquisition assembly may comprise at least two sensor assemblies, each arranged to sense an intensity of a respective one of the infrared partial beams. The second acquisition assembly may comprise a first sensor assembly arranged to sense an intensity of the first infrared partial beam, and a second sensor assembly arranged to sense an intensity of the second infrared partial beam.

The first infrared wavelength range and the second infrared wavelength range may be (fully) different from each other and/or adjacent to each other in this order. One of the infrared wavelength ranges may also be fully included in the respective other infrared wavelength range. The first infrared wavelength range and the second infrared wavelength range may be identical. The first infrared wavelength range and the second infrared wavelength range may be imaged differently to the corresponding sensor assemblies.

The at least two infrared wavelength ranges, particularly the first and/or second infrared wavelength ranges, may each contain at least one wavelength selected from: 1300 nm, 1400 nm, 1500 nm, 1600 nm, 1700 nm, 1800 nm, and 1900 nm. The first infrared wavelength range may contain 1500 nm and/or represent high temperatures. The second infrared wavelength range may contain 1900 nm and/or represent low temperatures. By sensing the intensity in two infrared wavelength ranges, heat-conduction (heat-dissipation) effects may be better sensed and monitored. Through the second infrared partial beam, for example, effects and operations taking place in the other environment of the machining area of the workpiece, for example, in laser welding in a larger distance to the keyhole or the melt pool, respectively, may be monitored. Moreover, with this, slightly glowing areas of the workpiece may be sensed and monitored. Through the first infrared partial beam, for example, effects and operations taking place at or on, respectively, the machining point of the workpiece, for example, in or in immediate proximity of the keyhole and/or in the melt pool, may be monitored. Moreover, with this, strongly glowing areas of the workpiece may be sensed and monitored.

The fourth visible wavelength range, the back-reflection wavelength range, and the first infrared wavelength range may be non overlapping each other and/or adjacent to each other in this order. Particularly, the fourth visible wavelength range and the back-reflection wavelength range may be adjacent to each other and the back-reflection wavelength range and the first infrared wavelength range may be adjacent to each other.

The beam splitter assembly may be configured for coupling out a plurality of partial beams from the process beam. The beam splitter assembly may comprise a plurality of beam splitters, particularly dichroitic beam splitters. The beam splitters may be formed as semi-transparent mirrors. The beam splitters may each comprise a wavelength-range specific coating, e.g., a dichroitic coating, wherein the wavelength-range specific coating is reflective or transmissive for a predetermined wavelength range. Particularly, the beam splitters may each comprise different coatings. Thereby, from each beam splitter, a respective partial beam with a specific wavelength or with a specific wavelength range, respectively, is coupled out.

The beam splitter assembly may comprise at least three or at least four or at least five or at least six beam splitters. The beam splitter assembly may comprise beam splitters of the primary to tertiary beam splitter orders. The beam splitter assembly may comprise beam splitters of the primary to sextiary beam splitter orders.

Each of the beam splitters may be arranged be of the beam axis of the process beam that entered through the optical input and/or on an optical axis defined by the optical input and/or by focusing optics. The beam splitters may be arranged in sequence along the beam axis of the process beam or an axis parallel to the beam axis of the process beam.

The beam splitter assembly may respectively include a primary, a secondary, and a tertiary beam splitter. The beam splitter assembly may respectively include exactly one primary, one secondary, and one tertiary beam splitter. The beam splitter assembly may also include exactly one beam splitter of each beam splitter order.

The beam splitter assembly may respectively include a primary, a secondary, a tertiary, a quaternary, a quinternary, a sextiary, etc. beam splitter. The beam splitter assembly may respectively include exactly one primary, exactly one secondary, exactly one tertiary, exactly one quaternary, exactly one quinternary, exactly one sextiary, etc. beam splitter. The beam splitter assembly may also include exactly one beam splitter of each beam splitter order.

The beam splitter assembly may comprise beam splitters of the primary to quaternary beam splitter orders. The beam splitter assembly may comprise a primary beam splitter. The beam splitter assembly may further comprise a first secondary beam splitter on the beam axis of the partial beam transmitted by the primary beam splitter and a second secondary beam splitter on the beam axis of the partial beam reflected by the primary beam splitters. The beam splitter assembly may further comprise a first tertiary beam splitter on the beam axis of the partial beam transmitted by the first secondary or the second secondary beam splitter, and a second tertiary beam splitter on the beam axis of the partial beam reflected by the first secondary beam splitter or the second secondary beam splitter. The beam splitter assembly may further comprise exactly one or at least one quaternary partial beam on the beam axis of a partial beam reflected or transmitted by the first tertiary beam splitters or the second tertiary beam splitter.

The beam splitter assembly may include one, particularly exact one beam splitter of the primary beam splitter order.

The beam splitter assembly may include at least two beam splitters of the secondary beam splitter order and/or may include at least two beam splitters of higher beam splitter orders than the secondary one.

The beam splitter assembly may comprise two beam splitters of the secondary and of the tertiary beam splitter assembly and one beam splitter of the quaternary beam splitter order.

The beam splitter assembly may comprise beam splitters of each of the primary beam splitter order and at least the secondary beam splitter order, or higher. The beam splitter assembly may also comprise beam splitters of each of the primary beam splitter order, the secondary beam splitter order, etc.

The beam splitter assembly may comprise beam splitters of each of the primary beam splitter order, the secondary beam splitter order, the tertiary beam splitter order, or higher. The beam splitter assembly may also comprise beam splitters of each of the primary beam splitter order, the secondary beam splitter order, the tertiary beam splitter order, etc.

The beam splitter assembly may comprise beam splitters of each of the primary beam splitter order, the secondary beam splitter order, the tertiary beam splitter order, the quaternary beam splitter order, or higher. The beam splitter assembly may also comprise beam splitters of each of the primary beam splitter order, the secondary beam splitter order, the tertiary beam splitter order, the quaternary beam splitter order, etc.

The beam splitter assembly may include exactly two, four, eight, or 16 beam splitters of each of the secondary beam splitter order and/or higher. For example, the beam splitter assembly of the secondary beam splitter order may include exactly two beam splitters, and/or may include exactly two or exactly four beam splitters of the tertiary beam splitter order, and may include exactly two or exactly four or exactly eight or exactly 16 beam splitters etc. of the quaternary beam splitter order.

These "branched" arrangements of the beam splitters have the aspect that the overall number of the interactions of the individual partial beams with a beam splitter is reduced compared to an easy serial arrangement of the beam splitter. A serial arrangement is characterized in that there is exactly one beam splitter from each beam splitter order (primary, secondary, tertiary, etc.). In contrast, in the branched arrangements, there may be multiple beam splitters of each beam splitter order (beginning with the secondary beam splitter order).

Each beam splitter may be a dichroitic beam splitter. Each (primary or secondary) beam splitter may be configured to reflect (or transmit) radiation in a predetermined wavelength range. Each (primary or secondary) beam splitter may be configured to transmit (or reflect) radiation with wavelengths outside this predetermined wavelength range.

The beam splitter assembly may comprise at least one filter arranged before or after one of the beam splitters. The beam splitter assembly may comprise at least one wavelength-range specific filter. The at least one wavelength-range specific filter may be arranged in the beam path of at least one partial beam of the process beam.

In the beam path of the optical input to at least one sensor assembly, at least two beam splitters of the beam splitter assembly may be arranged. That is, for at least one sensor assembly, the process beam may pass at least two beam splitters of the beam splitter assembly, before the process beam, as the corresponding partial beam, impinges on the sensor assembly. Therefore, the process beam is split at least twice by the beam splitters before the partial beam impinges on the sensor assembly. Thereby, the coatings of the two beam splitters may be optimized more easily compared to a split with only one beam splitter in the beam path to each sensor assembly, respectively. Because the wavelength ranges each beam splitter must cover may be adapted smaller.

In general, the monitoring device may comprise at least one sensor assembly with at least two optical sensors for measuring a partial beam of process radiation. Similarly, the monitoring device may comprise at least two sensor assemblies with at least two optical sensors for measuring respective partial beams of the process radiation. The remaining partial beams may be measured by sensor assemblies comprising exactly or at most one optical sensor.

The monitoring device may be arranged at the energy-beam machining head or at the laser machining head, respectively. In embodiments, monitoring device may be arranged on a housing of the machining head. In embodiments, the monitoring device may be flange-mounted to the housing of the machining head or formed flange-mountably to the housing. Particularly, the monitoring device may be arranged at an observation port of the housing. Particularly, the monitoring device may be arranged coaxially to the beam axis of the energy beam. Alternatively, the monitoring device may be arranged off axis to the beam axis.

Alternatively, the monitoring device may be fiber-bound. The monitoring device may comprise light reception optics in or at the machining head. The light reception optics may be external to the machining head. The light reception optics may be arranged coaxially to the beam axis of the energy beam.

The monitoring device may comprise at least one housing. The housing may comprise the optical input. The optical input may be formed such that the process beam enters the housing through the optical input of the monitoring device. The beam splitter assembly and/or the acquisition assemblies and/or the filter may be arranged within the housing. The monitoring device may further comprise a coupling device configured for coupling the monitoring device to a machining head. The coupling device may be mounted to the housing. The coupling device may, for example, comprise through holes for fastening means. The coupling device may be formed integrated with the housing or at the housing, respectively.

The monitoring device may further comprise at least one focusing optics, particularly a focusing lens. The at least one focusing optics may be arranged in or at, respectively, the optical input or in the beam path of the process beam between the optical input and the beam splitter assembly. Thus, the focusing optics may be arranged in the beam path of the process beam before a first split of the process beam, so that the full process beam entering or having entered, respectively, the monitoring device passes through the focusing optics.

The acquisition assemblies and/or the sensor assemblies may be each configured to generate corresponding sensor signals based on the sensed intensities. A sensor signal, particularly the strength of the sensor signal, may represent the intensity of the respectively sensed wavelength range. In embodiments, the sensor signals may be analog signals or digital signals, generated by conversion of an analog signal. The sensor signals may be voltage signals.

The energy-beam machining system may further comprise a control unit. The control unit may be configured for receiving and/or evaluating the sensor signals. Particularly, the control unit may be configured to evaluate the sensor signals separately from each other and/or to compare them with each other and/or to combine them with each other. Moreover, the control unit may be configured for controlling the machining process and/or for regulating the machining process based on the sensor signals. Particularly, the control unit may be configured to recognize, based on the sensor signals, whether there is a process defect of the machining process.

The control unit may be configured for evaluating and/or capturing the sensor signals. Evaluating the sensor signals may, particularly, take place for each of the sensor signals separately from the other sensor signals. Consequently, each wavelength range may be evaluated and monitored separately. The control unit may be configured to convert the (analog) sensor signals to digital signals.

The control unit may be configured to combine the individual sensor signals of the first acquisition assembly to a combined sensor signal. Thereby, the combined sensor signal may represent the overall or average intensity of the full visible wavelength range. The combined sensor signal may also represent the addition of the intensity of partial amounts of the visible wavelength ranges. The combining may occur by adding the sensor signal values of the individual sensor signals. The control unit may be configured to compare at least two of the individual sensor signals with each other. The comparing may occur by formation of quotients and/or subtraction of the sensor signal values of the two individual sensor signals.

The energy-beam machining system, particularly the control unit, may be configured to set an individual amplification for each sensor signal.

### BRIEF DESCRIPTION OF THE DRAWINGS

In the following, the present disclosure will be described in detail by the figures.

FIG. 1a shows an energy-beam machining system 100;

FIG. 1b shows an energy-beam machining system 100;

FIG. 2 shows an energy-beam machining process;

FIG. 3 shows selected sub-areas 51, 52, 53, 54, 55, 56 on a machined workpiece W;

FIG. 4 shows an intensity profile of process radiation from a workpiece W;

FIG. 5 shows an intensity profile of process radiation from a workpiece W;

FIG. 6 shows a sensor assembly 40;

FIG. 7 shows a selection of sub-areas on the workpiece W;

FIG. 8a shows an arrangement of sub-areas 51 on the workpiece W;

FIG. 8b shows another arrangement of sub-areas 51 on the workpiece W;

FIG. 8c shows another arrangement of sub-areas 51 on the workpiece W;

FIG. 8d shows another arrangement of sub-areas 51 on the workpiece W;

FIG. 8e shows another arrangement of sub-areas 51 on the workpiece W;

FIG. 8f shows another arrangement of sub-areas 51 on the workpiece W;

FIG. 9 shows a monitoring device 70;

FIG. 10 shows a monitoring device 70; and

FIG. 11 shows a monitoring device 70.

### DETAILED DESCRIPTION

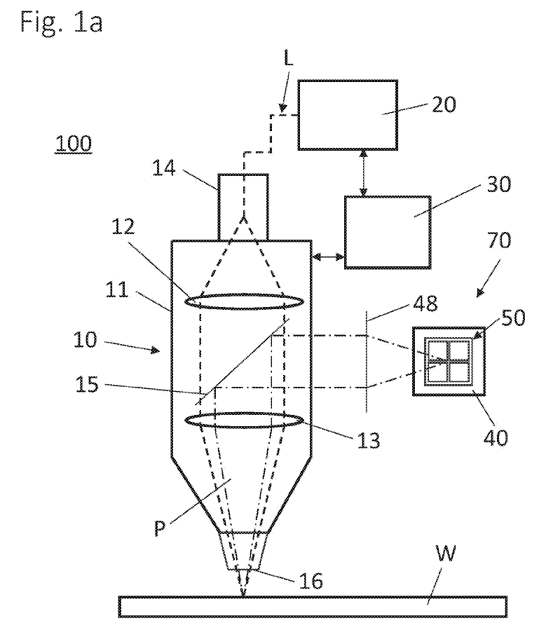

FIG. 1a shows an energy-beam machining system 100. The energy-beam machining system 100 may comprise an energy-beam machining head 10, a monitoring device 70, and a controller 30. The energy-beam machining system 100 may further comprise an energy-beam source 20. The monitoring device 70 comprises a sensor assembly 40. The controller 30 may be part of the energy-beam machining head 10 or part of the monitoring device 70. The energy-beam machining head 10 may comprise the monitoring device 70. The monitoring device 70 and the energy-beam machining head 10 are described with regard to FIG. 1a as part of the energy-beam machining system 100. The monitoring device 70 and the energy-beam machining head 10 may be independent or independent units, respectively.

The energy-beam source 20 may generate a machining-energy beam L (energy beam). In embodiments, the energy-beam source 20 is a laser beam source. The laser source may be formed as a single-mode laser, solid-state laser, fiber laser, high-power diode laser, or disc laser.

The machining-energy beam L generated by the energy-beam source 20 may be transmitted through an optical fiber from the energy-beam source 20 to the energy-beam machining head 10. Through a fiber coupler 14, the machining-energy beam L may be coupled into the energy-beam machining head 10. The fiber coupler 14 may be arranged on a housing 11 of the energy-beam machining head 10.

The energy-beam machining head 10 may comprise a collimation optics 12 (collimating optics). The collimation optics 12 may be arranged and formed in the energy-beam machining head 10 such that the machining-energy beam L divergently entering the energy-beam machining head 10 is being collimated. The collimation optics 12 may be arranged in the housing 11 of the energy-beam machining head 10.

The collimation optics 12 may comprise at least one lens or two or more lenses. A distance between the two or more lenses may be adjustable, particularly by an electric motor.

The energy-beam machining head 10 may comprise focusing optics 13. The focusing optics 13 may be arranged and formed in the energy-beam machining head 10 such that the collimated machining-energy beam L is focused. The focusing optics 13 may be arranged in the housing 11 of the energy-beam machining head 10. An optical path of the sensor assembly 40 may extend through the focusing optics 13.

The focusing optics 13 may comprise at least one lens or two or more lenses. A distance between the two or more lenses may be adjustable, particularly by an electric motor. The focusing optics 13 may be an F-Theta lens.

The focused machining-energy beam L may be radiated from the energy-beam machining head 10 and irradiated onto a workpiece W to machine the workpiece W.

The energy-beam machining head 10 may comprise an exit opening. From the exit opening, the energy beam may exit the energy-beam machining head 10 and radiate in the direction of the workpiece W. The exit opening may be formed as a nozzle 16 arranged at one end of the energy-beam machining head 10, particularly at an end of the housing 11 of the energy-beam machining head 10. Process radiation may enter the energy-beam machining head 10 through the exit opening.

The energy-beam machining head 10 may comprise a scanner device (not depicted in FIG. 1a). The scanner device may be configured to deflect the energy beam L onto a plurality of positions on the surface of the workpiece W. The scanner device may comprise at least one or at least two scanner elements, each tiltable or rotatable around one or two axes.

The workpiece W may be cut. In this course, the energy beam L may be radiated onto a surface of the workpiece W until an area of the workpiece W melts and/or evaporates. The energy beam L may be radiated onto the area the workpiece W until the workpiece W is penetrated (so-called piercing the workpiece). In this course, a hole may be formed in the workpiece W, through which the energy beam L may shine. The energy beam L may subsequently be moved along a machining path to form a cut in the workpiece W. Similarly, the workpiece W may be welded or soldered. Particularly, two workpieces W may be welded or soldered together.

The energy-beam machining head 10 may be an energy-beam printing head, an energy-beam ablation head, an energy-beam build-up welding head, an energy-beam cutting head, an energy-beam welding head, or an energy-beam soldering head.

By irradiating the energy beam L onto the workpiece W, process radiation P (here also referred to as process beam) occurs. The process radiation P may comprise reflected or backscattered energy radiation L, respectively. The process radiation P may comprise radiation emitted by the workpiece W. The emitted radiation may comprise radiation in different wavelength ranges, e.g., in the wavelength range visible to humans, in the infrared wavelength range, in the ultraviolet wavelength range, and in the wavelength range of the energy radiation L. The process radiation P may, emanating from the workpiece W, radiate into the energy-beam machining head 10, particularly through the exit opening.

The process radiation P from an area 50 on the workpiece W impinges on the sensor assembly 40, by which the process radiation P is measured. In this course, the sensor assembly 40 is configured to resolve at least two sub-areas on the workpiece. Further, the sensor assembly is 40 configured to sample each of the sub-areas with a frequency fu of at least 1 kHz.

The energy-beam machining system 100, particularly the monitoring device 70, may comprise an optical element 48. The optical element 48 may be arranged in the propagation direction of the process radiation P before the sensor assembly 40, particularly immediately before the sensor assembly 40. The optical element 48 may be formed to focus the process radiation P on the sensor assembly 40. The optical element 48 may be a focusing optics. The focusing optics may be an adjustable zoom focusing optics.

The ratio of the focal lengths of the focusing optics of the monitoring device 70 and of the focusing optics 13 results in an imaging ratio, i.e., how large the observation area of the sensors is on the workpiece. With the focusing optics of the monitoring device 70, the size of the image is adjustable.

The energy-beam machining head 10 may comprise a beam splitter 15. The beam splitter 15 may be arranged between the collimating optics 12 and the focusing optics 13, particularly in the optical path of the energy beam L between the collimating optics 12 and the focusing optics 13. The beam splitter 15 may be arranged between the collimating optics 12 and the scanner device, particularly in the optical path of the energy beam L between the collimating optics 12 and the scanner device. The beam splitter 15 may be transmissive for radiation with the wavelength of the energy beam L. For radiation with a wavelength of the process radiation P, the beam splitters 15 may be reflective. The beam splitter may also be reflective for the radiation with the wavelength of the energy beam L. For radiation with a wavelength of the process radiation P, the beam splitter 15 may be transmissive. In general, the beam splitter 15 may be configured, to split up radiation with the wavelength of the energy beam L and radiation with the wavelength of the process radiation P. The "coupled out" (coaxial) process radiation P may then be supplied to the monitoring device 70 and processed.

The process radiation P, emanating from the workpiece W, may radiate into the energy-beam machining head 10. In the energy-beam machining head 10, the optical paths of the energy beam L and of the process radiation P may overlay in sections. The process radiation P may pass the focusing optics 13 and impinge on the beam splitter 15, so that the process radiation P is coupled out of the beam path of the energy beam L. The process radiation P may then propagate towards the optical element 48 and be focused by the same on the sensor assembly 40. The beam path of the process radiation P may also occur in a different manner. From the workpiece W to the sensor assembly 40, the process radiation P may pass the scanner device, the optical element 48, particularly the varifocal lens and/or the zoom lens.

Process radiation P from the area 50 on the workpiece W may (by different optical elements) be imaged to the sensor assembly 40. By the sensor assembly 40, the at least two sub-areas may be resolved spatially.

In the embodiment of FIG. 1a, the process radiation P from an area 50 on the workpiece W impinges on the sensor assembly 40 by which the process radiation P is measured. In this course, the sensor assembly is 40 configured to resolve at least two sub-areas 51, 52, 53, 54, 55, 56 on the workpiece W. The sensor assembly 40 comprises at least two optical sensors 41, 42, 43, 44, 45, 46. In FIG. 1a, the sensor assembly 40 comprises four optical sensors 41, 42, 43, 44, 45, 46, by which the four sub-areas 51, 52, 53, 54, 55, 56 on the workpiece may be spatially resolved. The four optical sensors 41, 42, 43, 44, 45, 46 may be arranged in a 2 × 2 grid.

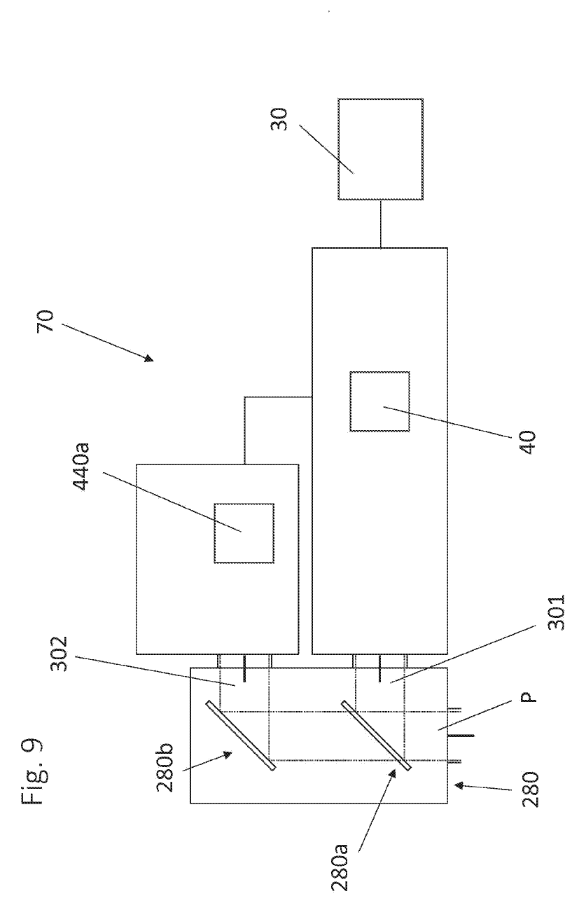

The monitoring device 70 may comprise more than one sensor assembly (see FIGS. 9-11). Each of the sensor assemblies may be each sensor assembly disclosed herein.

FIG. 1b shows an energy-beam machining system 100. The energy-beam machining system 100 of FIG. 1b may be formed substantially identical to the energy-beam machining system 100 of FIG. 1a. The same components and functions are not repeated. The components and functions described with regard to the energy-beam machining system 100 of FIG. 1a are also disclosed for the energy-beam machining system 100 of FIG. 1b.

In the embodiment of FIG. 1b, the monitoring device 70 comprises (exactly) one optical fiber 47 per resolved sub-area 51, 52, 53, 54, 55, 56 and/or per optical sensor 41, 42, 43, 44, 45, 46 of the sensor assembly 40. Process radiation P impinging on the sensor assembly 40 from the workpiece W may be forwarded from the optical fibers 47 to the optical sensors 41, 42, 43, 44, 45, 46. The arrangement of the optical fibers 47 on the sensor assembly 40 may correspond, particularly be identical, to the arrangement of the sub-areas 51, 52, 53, 54, 55, 56. The arrangement of the optical sensors 41, 42, 43, 44, 45, 46 may not correspond, particularly be not identical, to the arrangement of the sub-areas 51, 52, 53, 54, 55, 56.

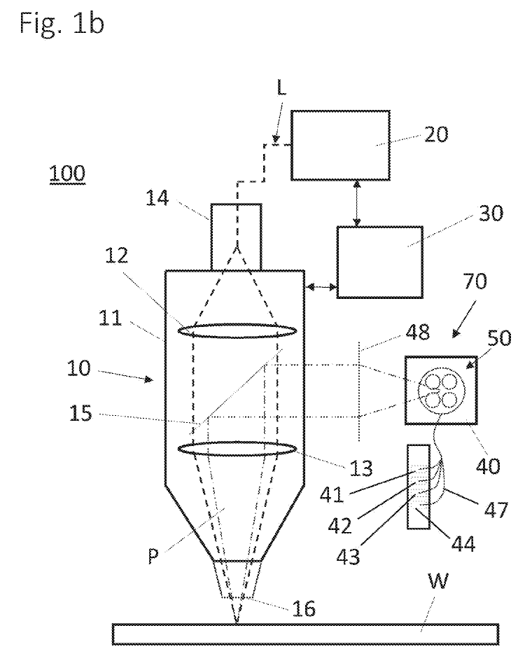

FIG. 2 shows an energy-beam machining process, specifically an energy-beam welding process. From the energy-beam machining head 10, the energy beam L impinges on the surface of the workpiece W. In this course, the energy beam L may impinge on the machining point 60. The machining point 60 may be formed with a keyhole. Around the machining point 60, edge areas may be defined. Particularly, a melt pool 61 (melted workpiece) and a weld 65 (solidified melt) may be defined. In FIG. 2, the machining direction is indicated by the arrow on the workpiece. In the machining point 60, the melt pool 61, the weld 65 and the edge areas thereof, process radiation P occurs, which spreads emanating from the workpiece W towards the energy-beam machining head 10.

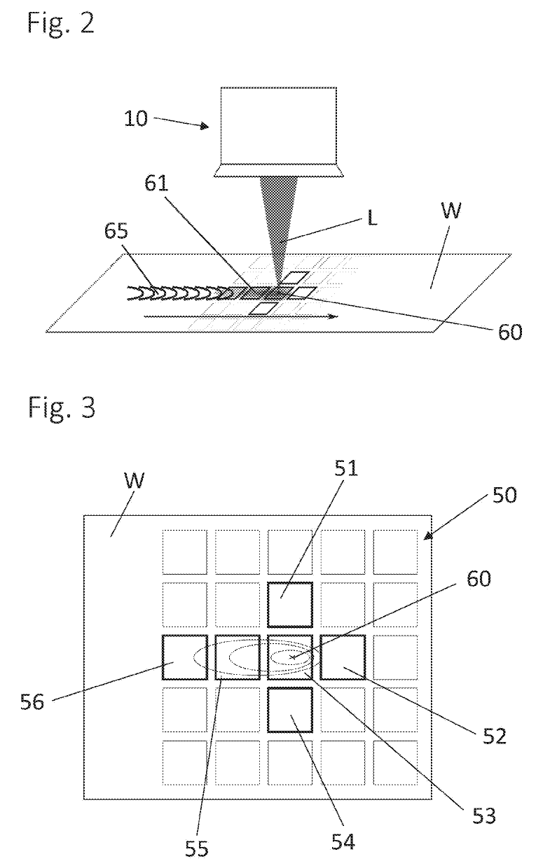

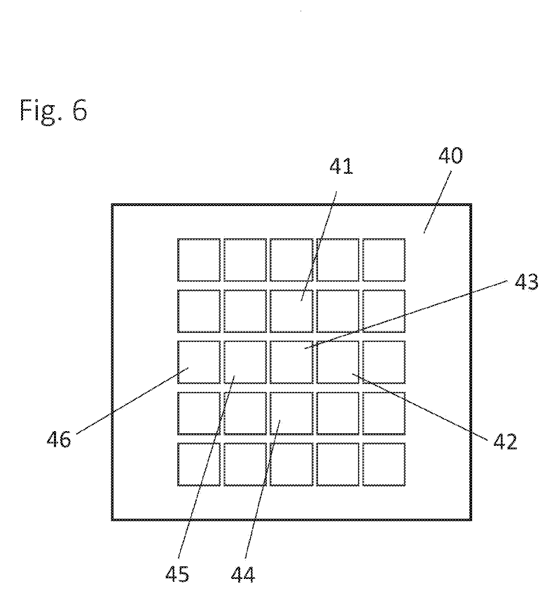

FIG. 3 shows an area 50 on a workpiece W. The machining point 60 of the energy beam L of the energy-beam machining head 10 is in the center of the area 50. In the area 50, six sub-areas 51, 52, 53, 54, 55, 56 are selected by way of example. The selected sub-areas 51, 52, 53, 54, 55, 56 are also highlighted by the thick border in FIG. 2. Overall, in FIGS. 3, 5, × 5 sub-areas 51, 52, 53, 54, 55, 56 are illustrated, which, in this example, are measurable or resolvable, respectively, with the sensor assembly 40. In a case where the machining point 60 of the energy beam L is, in the course of the machining process on the workpiece W, being moved to the right, the sub-area 52 comprises the downstream, the sub-area 53 the machining point 60, the sub-areas 55 and 56 the upstream, and the sub-areas 51 and 54 edge areas. In a case where process radiation P occurs during the energy-beam machining process and impinges on the sensor assembly 40, the area 50 is resolved by the sensor assembly 40 into the desired number of sub-areas. In the example of FIG. 3, these are six sub-areas. A different number of sub-areas is possible, for example, at least two sub-areas.

As has been described already, process radiation P from the area 50 on the workpiece W is imaged to the sensor assembly 40. Resolving the sub-areas 51, 52, 53, 54, 55, 56 occurs by the sensor assembly 40, particularly by the optical sensors or the optical fibers.

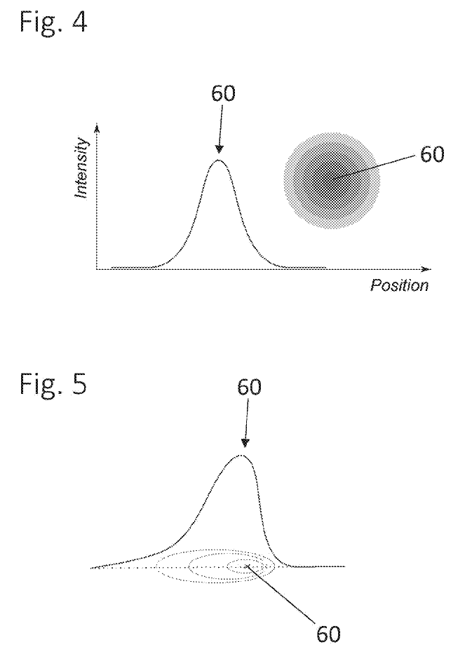

In FIGS. 4 and 5, a 1D intensity profile of the process radiation P is shown, respectively. In this course, intensity is drawn versus position. The circle with a plurality of ring segments symbolizes the intensity of the process radiation P emanating from the machining point 60 in the center. The intensity of the process radiation P decreases exponentially with the distance from the machining point 60. This results, at a spatial resolution, in significant intensity differences for the sub-areas. The circular intensity profile of FIG. 4 is schematic for the example of a spot-welding process. In a weld line, there is a deviation from the circular shape, see FIG. 5.

By individual drivability or ability to read out of the individual optical sensors, respectively, less relevant areas may be suppressed. Thereby, the amount of data is reduced and/or the sampling frequency may be increased. Additionally, the dynamic range is increased.

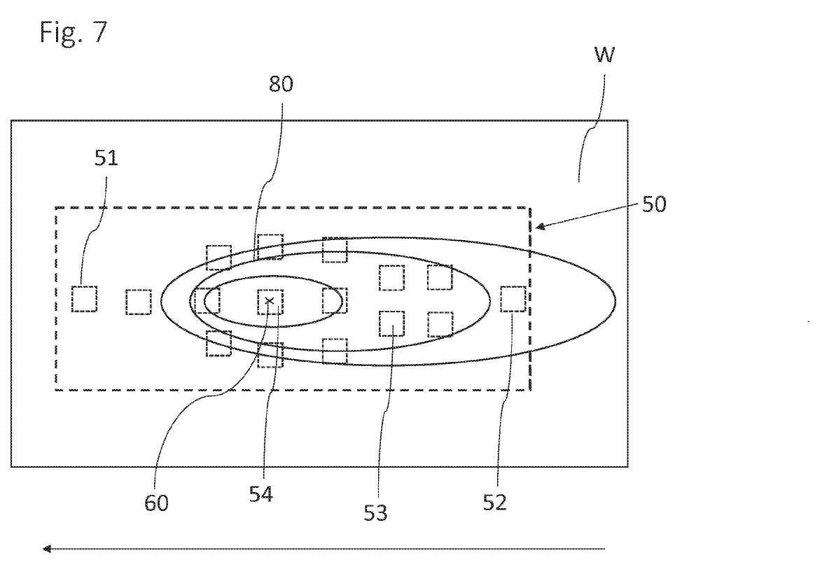

In FIG. 6, a sensor assembly 40 is shown. The sensor assembly 40 comprises a total of 25 optical sensors 41, 42, 43, 44, 45, 46 (not all sensors are provided with a reference sign). Instead of the optical sensors, (ends of) optical fibers may be arranged on the sensor assembly 40. The optical fibers may forward the process radiation P to optical sensors respectively connected therewith. Per optical sensor, (exactly) one optical fiber may be provided.

Each of the optical sensors 41, 42, 43, 44, 45, 46 resolves a sub-area 51, 52, 53, 54, 55, 56 on the workpiece W or corresponds to a sub-area 51, 52, 53, 54, 55, 56 on the workpiece W, respectively. In a case where the process radiation P stemming from the area 50 impinges on a corresponding area of the sensor assembly 40, in which the 25 optical sensors 41, 42, 43, 44, 45, 46 are arranged, a measurement signal is generated by each of the optical sensors 41, 42, 43, 44, 45, 46. Thereby, the area 50 is being (spatially) resolved.

Each of the optical sensors 41, 42, 43, 44, 45, 46 may be individually read out, individually driven, individually amplified, individually selected, individually turned on and off, and/or individually evaluated. For example, all optical sensors 41, 42, 43, 44, 45, 46 may be initially activated. In a first evaluation, it is determined that one of the optical sensors 41, 42, 43, 44, 45, 46 is not relevant for the evaluation. This optical sensor may then be deactivated for subsequent measurements, so that fewer measurement signals are generated per scan. Also, each of the optical sensors 41, 42, 43, 44, 45, 46 may be selectable. Similarly, the sampling frequency may be increased per sub-area, when fewer sub-areas are considered.

Individual optical sensors may be individually filtered (by an optical filter) or amplified. Thereby, the sensor assembly is flexibly adjustable to the measurement task.

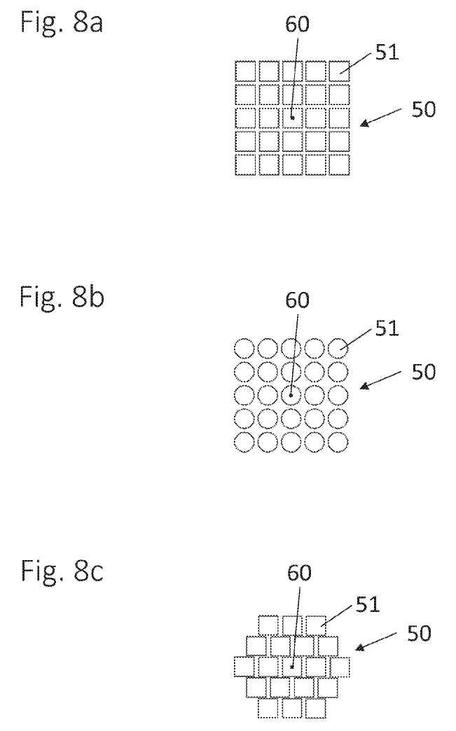

FIG. 7 shows a schematic view of an area 50 observed by the sensor assembly 40. In the area 50, multiple sub-areas are resolved.

The area 50 includes an energy-beam welding process. A feed direction of the energy-beam welding process extends along the direction indicated by the arrow. The area 50 comprises the machining point 60 with the TCP and a melt pool 80 of the melted material of the workpiece W surrounding the machining point 60. The area 50 or the melt pool 80, respectively, are surrounded by an area in which the material of the workpiece W is being heated, but not yet melted or already solidified again, respectively. The image also shows the area 50 and the environment of the same.

In a first measurement, all optical sensors may be activated, i.e., information or measurement signals, respectively, may be received from all resolved sub-areas. Subsequently, some the optical sensors may be deactivated, to select a subset the optical sensors. For subsequent measurements, only the subset of the optical sensors, i.e., the selected optical sensors, may be considered. In the case of FIG. 7, these are the optical sensors 51 (in the downstream), 54 (in the keyhole), 53 (in the melt pool) and 52 (in the upstream after the melt pool).

This information obtained by the selected optical sensors or the selected sub-areas, respectively, may suffice to sufficiently monitor the energy-beam machining process. Nonetheless, the amount of data may be reduced – versus an observation by all optical sensors – and/or the sampling frequency per sub-area may be increased.

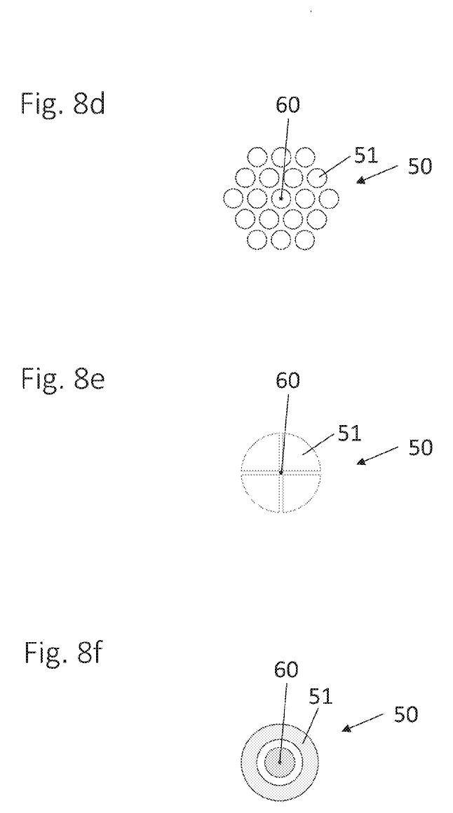

In the FIGS. 8a-8f, different arrangements of sub-areas 51 etc. are depicted in the area 50 on the workpiece W. As described above, the arrangement of the sub-areas corresponds or is identical, respectively, to the arrangement of the optical sensors or the arrangement of (ends of) optical fibers.

The sub-areas may be arranged on a grid (FIG. 8). On the grid, there may be gaps and rows. The gaps may be oriented substantially (±10° or ±5°) perpendicularly to the rows. In each gap, there may be the same number of sub-areas as in each row. In embodiments, the number of sub-areas in the gaps and/or in the rows is odd. The column spacing between adjacent gaps may be substantially (±10% or ±5%) identical to the row spacing between adjacent rows. The sub-areas 51 etc. may be formed quadrangularly, particularly squarely (see FIGS. 8a) or circularly (FIG. 8b).

In embodiments, 3 × 3 sub-areas (overall 9 sub-areas), 5 × 5 sub-areas (overall 25 sub-areas), or 7 × 7 sub-areas (overall 49 sub-areas) may be resolved in the area 50 on the workpiece W. In embodiments, 5 × 5 sub-areas (overall 25 sub-areas) are spatially resolved in the area 50 on the workpiece W.

The area 50 may be positioned such that the machining point 60 may be located in the center of the area 50.

As shown in FIGS. 8c and 8d, the number of sub-areas 51 per column may vary, i.e., the number of sub-areas 51 may be different in different gaps. Alternatively or additionally, the number of sub-areas 51 per row may vary, i.e., the number of sub-areas 51 may be different in different rows.

The closer a gap or row, respectively, lies to the center of the area 50 (or the machining point 60), the larger the number of the sub-areas 51 may be.

The sub-areas 51 may be arranged in a hexagonal pattern.

The sub-areas 51 etc. may be formed quadrangularly, particularly squarely (see FIGS. 8c) or circularly (FIG. 8d).

As shown in FIG. 8e, the sub-areas 51 may be arranged in the shape of circle quadrants. In FIG. 8f, a sub-area 51 is arranged centered and at least another sub-area is oriented annularly around the centered sub-area. A plurality of annular-ring shaped sub-areas may be provided centered around the sub-area. In this course, an annular-ring shaped sub-area may respectively be farther radially outside than the preceding annular-ring shaped sub-area. In embodiments, at least 2, at least 3, or at least 4 annular-ring shaped sub-areas may be provided.

The annular-ring shaped sub-areas may be divided (in circumferential direction) in other sub-areas. For example, an annular-ring shaped sub-area (in circumferential direction) may be divided in at least 2, at least 3, or at least 4 sub-areas. The number of the sub-areas, into which the annular-ring shaped sub-area is divided, may increase with increasing distance (in the radial direction) of the centered sub-area.

In general, the optical sensors 41, 42, 43, 44, 45, 46 may be formed monolithically. In this course, the optical sensors 41, 42, 43, 44, 45, 46 may be manufactured lithographically. Alternatively, the optical sensors 41, 42, 43, 44, 45, 46 may be provided by an arrangement of photodiodes. The sensor assembly 40 then comprises a number of separate photodiodes.

The present disclosure stands opposite process monitoring with a camera. The higher spatial resolution comes with a reduced data acquisition rate (reduced temporal resolution), as a camera typically records much information "unnecessary" for process monitoring (image areas non relevant and/or with too high resolution). In addition, the intensity differences in the different process areas impose very high requirements on the dynamic range of the sensor, which is solved in the apparatus of the present disclosure by the separate signal amplification of all optical sensors. Furthermore, another "unnecessary" split of the light intensity of the process radiation from a coarsely rasterized homogenous sub-area adversely affects other sensors (corresponding to a high spatial camera resolution), as the detectable light amount decreases per optical sensor and, therefore, may be lower than its sensitivity threshold, and/or the signal-to-noise ratio decreases correspondingly.

The present disclosure exploits the decisive aspects of spatial and temporal resolution, without including the adverse properties of the known systems.

For example: In a case where the error dependency of the process emission differs regarding area but shows the same behavior within coarsely rasterized process zones, it is expedient to measure spatially resolved, but it is not necessary to observe the individual areas with megapixel resolution. In contrast, resources, cost, etc. may be saved while working with a high rate of measurement, as well as the amplification may be set appropriately for the corresponding areas.

FIG. 9 shows a monitoring device 70. The monitoring device 70 comprises a beam splitter assembly 280. The beam splitter assembly 280 may comprise a beam splitter 280a that allows at least one first partial beam 301 to be coupled out from the process radiation P, so that there are at least one first and one second partial beam 301, 302 of the process radiation P. The second partial beam 302 of the process radiation may be redirected by an optical element 280b, e.g., a mirror.

The monitoring device 70 may comprise one or more focusing optics. Each of the focusing optics may be a focusing lens. The one or more focusing optics may be configured to focus the process radiation P.

The monitoring device 70 may comprise at least one first focusing optics (not shown in FIG. 9) configured to focus the first partial beam 301. The first focusing optics may be arranged between the beam splitter 280a and the sensor assembly 40.

The monitoring device 70 may comprise at least one second focusing optics (not shown in FIG. 9) configured to focus the second partial beam 302. The second focusing optics may be arranged between the optical element 280b and the sensor assembly 440a.

In embodiments, the monitoring device 70 comprises at least the first and second focusing optics. It is possible that the monitoring device 70 comprises only the first or only the second focusing optics. Other focusing optics are possible.

Each sensor assembly may be associated with a focusing optics able to respectively focus a partial beam of the process radiation on the sensor assembly. The monitoring device 70 may comprise at least or exact the same number of focusing optics as sensor assemblies.

The monitoring device 70 may comprise a common focusing optics (not shown in FIG. 9). The common focusing optics may be arranged (in the propagation direction of the process radiation P) before the beam splitter 280a. Thereby, the process radiation P may impinge in a focused manner on the beam splitter 280a. The common focusing optics may be configured to focus the process radiation P at least on the sensor assemblies 40, 440a.

The monitoring device 70 comprises a sensor assembly 40 for measuring the first partial beam 301 of the process radiation P. The sensor assembly 40 may be each sensor assembly described herein. In embodiments, the sensor assembly 40 comprises at least two optical sensors. Thereby, the measurement of the sensor assembly 40 may be conducted in a spatially resolved manner.

In embodiments, the monitoring device 70 comprises one (other) sensor assembly 440a. The (other) sensor assembly 440a may measure the second partial beam 440a. The sensor assembly 40 may be each sensor assembly described herein. In embodimentsm, the (other) sensor assembly 440a comprises exactly or at most one optical sensor. The measurement may not be conducted by the (other) sensor assembly 440a in a spatially resolved manner.

In embodiments, the monitoring device 70 comprises a sensor assembly 40 for measuring the first partial beam 301 of the process radiation P, which at least comprises two optical sensors and a sensor assembly 440a for measuring the second partial beam 302 of the process radiation P, which comprises at most or exactly one optical sensor.

The monitoring device 70 may comprise two sensor assemblies for measuring respective partial beams of the process radiation P, which each comprises at least two optical sensors, and a sensor assembly 440a for measuring a partial beam of process radiation P, which comprises at most or exactly one optical sensor.

The monitoring device 70 may comprise a sensor assembly 40 for measuring a partial beam of process radiation P, which comprises at least two optical sensors and multiple (e.g., at least two, at least three, at least four, at least five, or at least six) sensor assemblies for measuring a respective partial beam of process radiation P, which each comprise at most or exactly one optical sensor.

The monitoring device 70 may comprise at least two sensor assemblies for measuring a respective partial beam of process radiation P, which each comprise at least two optical sensors and multiple (e.g., at least two, at least three, at least four, at least five, or at least six) sensor assemblies for measuring a respective partial beam of process radiation P comprising at most or exactly one optical sensor.

The monitoring device 70 may comprise a controller 30 (also referred to as control unit). The controller 30 may receive the sensor signals of all sensor assemblies. The controller 30 may be configured for regulating the machining process based on the received sensor signals. Particularly, the controller 30 may be configured to recognize, based on the received sensor signals, whether a process defect of the machining process occurred. The controller 30 may also be configured to, to set an individual amplification for each sensor signal. The controller 30 may further be configured for evaluating and/or for capturing the sensor signals. Evaluating the sensor signals may occur, in particular, for each of the sensor signals separately or separately from the other sensor signals. Consequently, each wavelength range may be monitored and evaluated separately.

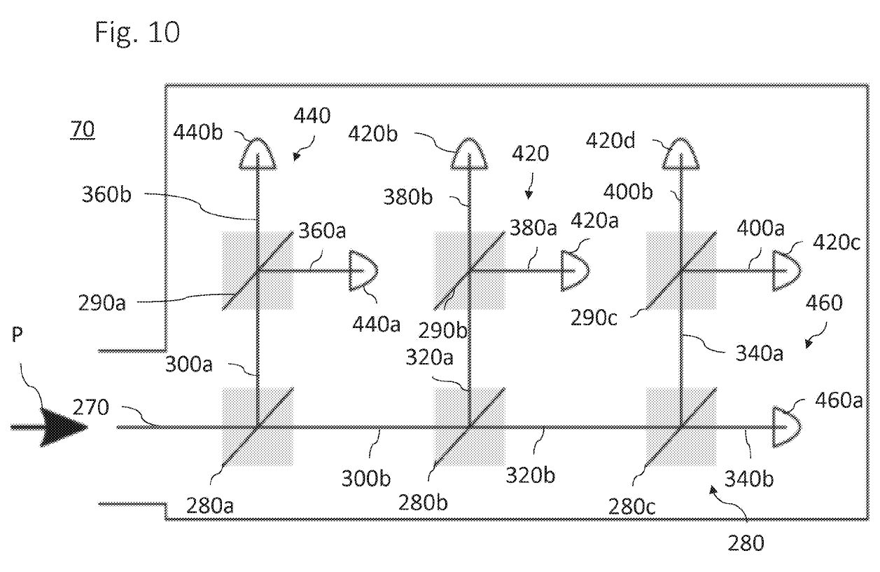

FIG. 10 shows a monitoring device 70 according to embodiments the present disclosure.

The monitoring device 70 may comprise focusing optics (not shown), e.g., a focusing lens, for focusing the process beam P coupled into the monitoring device 70. The beam axis 270 of the process beam P coincides with an optical axis of the focusing optics. The focusing optics may be provided for focusing the process beam P or the later described partial beams, respectively, on sensor assemblies also described later. The present disclosure is not limited to this. The process beam P may also enter in a collimated manner into the monitoring device 70.

The monitoring device 70 may comprise at least two focusing optics (not shown in FIG. 10). Each of the focusing optics may be arranged in a (other) partial beam of process radiation. Particularly, each sensor assembly may be associated with a focusing optics, able to focus a respective partial beam of process radiation on the sensor assembly. The monitoring device 70 may comprise at least or exactly the same number of focusing optics as sensor assemblies.

The monitoring device 70 may comprise a beam splitter assembly 280 as well as a first acquisition assembly 420 for sensing the intensity of the process beam P in the visible wavelength range, and a second acquisition assembly 440 for sensing the intensity of the process beam P in the infrared wavelength range. As shown in FIG. 10, the monitoring device 70 may further comprise a third acquisition assembly 460 for sensing the intensity of the process beam P in the back-reflection wavelength range. Each of the acquisition assemblies 420, 440, 460 comprises at least one sensor assemblies 420a, 420b, 420c, 420d, 440a, 440b, 460a. The beam splitter assembly 280 serves for splitting the process beam P, to couple out partial beams with different wavelength ranges from the process beam P and lead them to the sensor assemblies of the acquisition assemblies 420, 440, 460, respectively. A sensor assembly may be each sensor assembly disclosed herein.

The beam splitter assembly 280 comprises, for example, a plurality of beam splitters formed as semi-transparent mirrors. The beam splitters may each comprise a reflective wavelength-range specific coating and/or a transmissive wavelength-range specific coating. Thereby, by each beam splitter of the beam splitter assembly 280, a partial beam with a specific wavelength range will be reflected or transmitted, respectively. The beam splitter assembly 280 may further comprise at least one wavelength-range specific filter (not shown) arranged in the beam path of at least one partial beam of the process beam.

Generally, none of the monitoring devices described herein are limited to a number of sensor assemblies. The number of sensor assemblies shown in specific examples is exemplary and may be lower or higher, also in the specific examples.

The beam splitter assembly 280 shown in FIG. 10 exemplarily comprises a primary beam splitter 280a, a first secondary beam splitter 280b, and a first tertiary beam splitter 280c, arranged one after the other on a line or axis, respectively. The primary beam splitter 280a is arranged as a first beam splitter in the beam path of the process beam P along the beam axis 270 after the focusing optics. The primary beam splitter 280a splits the process beam P into two partial beams. A first part of the process beam P is reflected as a first primary reflected partial beam 300a. A second part of the process beam P is transmitted as a first primary transmitted partial beam 300b. A beam axis of the partial beam 300b after the beam splitter 280a may substantially coincide with or be parallel to the beam axis of the process beam P entering the monitoring device 70 before the primary beam splitter 280a.

The first secondary beam splitter 280b is arranged in the beam path of the partial beam 300b transmitted by the beam splitter 280a. The beam splitter 280b splits the transmitted partial beam 300b into two parts. A first part of the partial beam 300b is reflected as a first secondary reflected partial beam 320a. A second part of the partial beam 300b is transmitted as a first secondary transmitted partial beam 320b. A beam axis of the partial beam 320b after the beam splitter 280b may substantially coincide with or be parallel to the beam axis of the partial beam 300b before the beam splitter 280b and/or the beam axis of the process beam P before the beam splitter 280a.

The first tertiary beam splitter 280c is arranged in the beam path of the partial beam 320b transmitted by the beam splitter 280b. The beam splitter 280c splits the transmitted partial beam 320b into two parts. A first part of the partial beam 320b is reflected as a first tertiary reflected partial beam 340a. A second part of the partial beam 320b is transmitted as a first tertiary transmitted partial beam 340b. A beam axis of the partial beam 340b after the beam splitter 280c may substantially coincide with or be parallel to the beam axis of the partial beam 320b before the beam splitter 280c and/or the beam axis of the process beam P before the beam splitter 280a.

The beam splitter assembly further comprises a second secondary beam splitter 290a, a second tertiary beam splitter 290b, and a quaternary beam splitter 290c. In the beam path of the partial beam 300a reflected by the primary beam splitter 280a, the second secondary beam splitter 290a is arranged. The beam splitter 290a splits the reflected partial beam 300a into two parts. A first part of the partial beam 300a is reflected as a second secondary reflected partial beam 360a. A second part of the partial beam 300a is transmitted as a second secondary transmitted partial beam 360b. A beam axis of the partial beam 360b after the beam splitter 290a may substantially coincide with or be parallel to the beam axis of the partial beam 300a before the beam splitter 290a.

In the beam path of the partial beam 320a reflected by the first secondary beam splitter 280b, the second tertiary beam splitter 290b is arranged. The beam splitter 290b splits the reflected partial beam 320a into two parts. A first part of the partial beam 320a is reflected as a second tertiary reflected partial beam 380a. A second part of the partial beam 320a is transmitted as a second tertiary transmitted partial beam 380b. A beam axis of the partial beam 380b after the beam splitter 290b may substantially coincide with or be parallel to the beam axis of the partial beam 320a before the beam splitter 290b.

In the beam path of the partial beam 340a reflected by the first tertiary beam splitter 280c, the quaternary beam splitter 290c is arranged. The beam splitter 290c splits the reflected partial beam 340a into two parts. A first part of the partial beam 340a is reflected as a quaternary reflected partial beam 400a. A second part of the partial beam 340a is transmitted as a quaternary transmitted partial beam 400b. A beam axis of the partial beam 400b after the beam splitter 290c may substantially coincide with or be parallel to the beam axis of the partial beam 340a before the beam splitter 290c.

The beam splitter assembly 280 is not confined to the embodiment shown in FIG. 10.

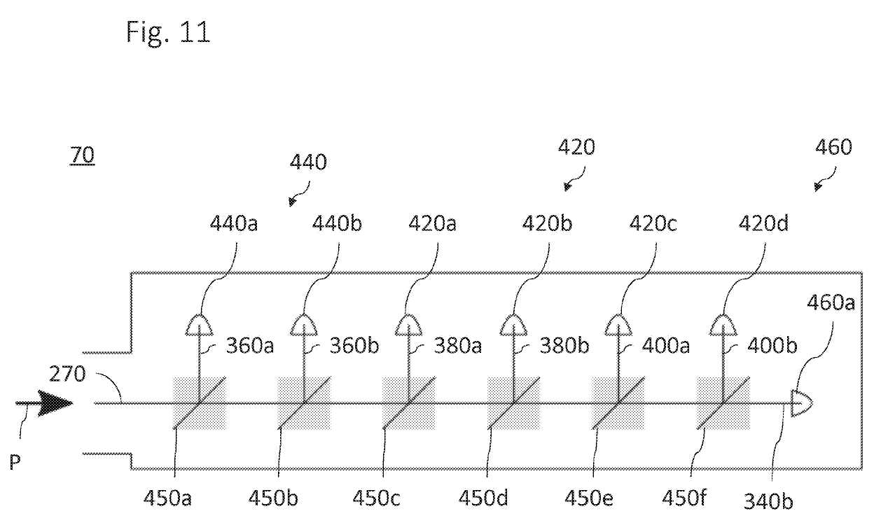

In FIG. 11, another embodiment of a monitoring device 70 is shown. Therein, the beam splitter assembly 280 comprises six beam splitters arranged in a row along the beam axis 270 of the process beam P entering the monitoring device 70. The monitoring device of FIG. 10 comprises a primary beam splitter 450a, a secondary beam splitter 450b, a tertiary beam splitter 450c, a quaternary beam splitter 450d, a quinternary beam splitter 450e, and a sextiary beam splitter 450f. Each the primary to quinternary beam splitters 450a-450e serves for coupling out a corresponding partial beam 360a, 360b, 380a, 380b, 400a, 400b. The sextiary beam splitter serves for coupling out the partial beams 400b and 460a.

The partial beams 380a, 380b, 400a, 400b have visible wavelength ranges different from each other. These partial beams serve for sensing intensities of the process beam P in the different visible wavelength ranges and may therefore also be denoted as visible partial beams. For example, the first partial beam 380a may comprise a first visible wavelength range around 400 nm and may serve for sensing atomic emission lines, particularly atomic emission lines of aluminum or iron. The second partial beam 380b may comprise a second visible wavelength range around 500 nm and may, for example, serve for sensing molecular emission bands, e.g., aluminum oxide. The third partial beam 400a may comprise a third visible wavelength range around 600 nm and may serve for sensing molecular emission bands, e.g., iron oxide. The fourth partial beam 400b may comprise a fourth visible wavelength range around 750 nm. The fourth visible wavelength range may reach into the near infrared range.

The shown beam splitter assembly 280 couples out four visible partial beams. However, the present disclosure is not limited thereto. The beam splitter assembly 280 may, for example, also couple out only two visible partial beams, for example, the first visible partial beam 380a and the second visible partial beam 380b or the first visible partial beam 380a and the third visible partial beam 400a.

The partial beams 360a, 360b comprise infrared wavelength ranges different from each other. These partial beams serve for sensing intensities of the process beam P in the different infrared wavelength ranges and may therefore also be referred to as infrared partial beams. The first infrared partial beam 360a may comprise an infrared wavelength range around 1500 nm. This infrared partial beam 360a may serve for sensing thermal radiation representing a high temperature. Thereby, for example, effects and operations taking place in the area of the keyhole and/or the melt pool may be monitored. The second infrared partial beam 360b may comprise an infrared wavelength range around 1900 nm. This infrared partial beam 360bmay serve for sensing thermal radiation including low temperatures. Thereby, for example, effects and operations relating to the thermal conduction emanating from the point of impact of the energy or laser beam, respectively, on the workpiece or emanating from the keyhole or the melt pool, respectively, may be monitored.

The partial beam 340b comprises the wavelength of the energy beam. It serves for sensing an intensity of the back-reflection of the energy beam from the workpiece W as a part of the process beam P and may therefore also be denoted as a back-reflection partial beam 340b.

The beam splitter assembly 280 leads the partial beams 380a, 380b, 400a, 400b to each of a sensor assembly of the first acquisition assembly 420 for sensing the intensity of the process beam P in the visible wavelength range. The first acquisition assembly 420 comprises, in the shown example, four sensor assemblies 420a-420d. Each of the four sensor assemblies 420a-420d is arranged to sense the intensity of exactly one of the partial beams 380a, 380b, 400a, 400b. For example, the first sensor assembly 420a senses the intensity of the first visible partial beam 380a, and so on. However, by the design of the beam splitter assembly 280 coupling out the different partial beams 380a, 380b, 400a, 400b with different visible wavelength ranges from the process beam P, the intensities of the different visible wavelength ranges may still be sensed and monitored separately from each other.

The beam splitter assembly respectively leads the partial beams 360a, 360b to a sensor assemblies of the second acquisition assembly 440 for sensing the intensity of the process beam P in the infrared wavelength range. The second acquisition assembly 440 in the shown example comprises two sensor assemblies 440a, 440b. Each of the two sensor assemblies 440a, 440b is arranged to sense the intensity of exactly one of the partial beams 360a, 360b. For example, the first sensor assembly 440a senses the intensity of the first infrared partial beam 360a. By the design of the beam splitter assembly 280 coupling out the different partial beams 360a, 360b with different visible wavelength ranges from the process beam P, the intensities of the different infrared wavelength ranges may still be sensed and monitored separately from each other. However, the two sensor assemblies 440a, 440b may comprise different sizes of the sensor areas. Particularly, the first sensor assembly 440a may comprise a sensor area limited to the illustration of the machining area, e.g., the keyhole or the melt pool. The second sensor assembly 440b may comprise a sensor area allowing imaging the machining area and its environment. In other words, the second sensor assembly 440b may comprise a larger sensor area than the first sensor assembly 440a.

The beam splitter assembly leads the partial beam 340b to a third acquisition assembly 460 for sensing the intensity of the process beam P in the back-reflection wavelength range. The third acquisition assembly 460 comprises a sensor assembly 460a arranged to sense an intensity of the back-reflection partial beam 340b.

The beam splitter assembly 280, the acquisition assemblies 420, 440, 460, and, if applicable, other filter and optical elements such as the focusing optics may be arranged within a housing (not shown in FIG. 11).

The sensor assemblies of all acquisition assemblies 420, 440, 460 are respectively configured to generate, based on the respectively sensed intensity of a corresponding sensor signal, e.g., an analog voltage signal. For example, the voltage strength may be a measure for the intensity of the respectively sensed wavelength range.

The machining system 100 may comprise a control unit (the "control unit" is herein also referred to as a controller 30) receiving the sensor signals of all sensor assemblies. The control unit may be configured for regulating the machining process based on the received sensor signals. Particularly, the control unit may be configured to recognize, based on the received sensor signals, whether a process defect of the machining process has occurred. Moreover, the control unit may be configured to set an individual amplification for each sensor signal.

The control unit may further be configured for evaluating and/or for capturing the sensor signals. Evaluating the sensor signals may, in particular, occur for each of the sensor signals separately or separate from the other sensor signals. Consequently, each wavelength range may be evaluated and monitored separately.

Through the beam splitter assembly, it is possible to allow a monitoring of machining processes in a plurality of wavelength ranges and to simultaneously optimize the optical imaging of each individual wavelength range or channel, respectively, separate from each other. The monitoring device allows, for example, an optimized interpretation of the imaging by being able to appropriately select the sensor area size of each individual sensor assembly. Additionally, the described apparatus allows to amplify the sensor signals of each individual sensor assembly separate from each other. Thus, usually the signal of the back-reflection may have a very high intensity. In comparison, the intensity of the emission in the temperature range is typically orders of magnitude lower. In general, the partial beams may have signal intensities different by orders of magnitude. Therefore, being able to set the signals of the sensor assemblies separate from each other is desirable. This is allowed by the monitoring device of the present disclosure and is not or not easily feasible, respectively, with typical spectrometers due to the CCD or CMOS design, respectively.

A first aspect of the present disclosure is a monitoring device (70) for monitoring an energy-beam machining process on a workpiece (W), wherein said monitoring device (70) comprises a sensor assembly (40) for measuring process radiation (P) occurring at said energy-beam machining process, said sensor assembly (40) comprises at least two optical sensors (41, 42, 43, 44, 45, 46) and is configured to resolve at least two sub-areas (51, 52, 53, 54, 55, 56) on said workpiece (W), and said sensor assembly (40) is configured to sample each of said sub-areas (51, 52, 53, 54, 55, 56) with a frequency fu of at least 1 kHz.

A second aspect of the present disclosure is a monitoring device according to the first aspect, wherein the sensor assembly (40) is configured to sample each of said sub-areas (51, 52, 53, 54, 55, 56) with a frequency fu of at least 5 kHz, at least 20 kHz, at least 50 kHz, at least 100 kHz, or at least 250 kHz.

A third aspect of the present disclosure is a monitoring device according to the first aspect or second aspect, wherein the sensor assembly (40) is configured to sample each of said sub-areas (51, 52, 53, 54, 55, 56) with a frequency fu of fu = f0/u, wherein u is the number of said sub-areas (51, 52, 53, 54, 55, 56) and f0 is the overall frequency, wherein said overall frequency f0 is at least 100 kHz, at least 250 kHz, at least 500 kHz, at least 750 kHz, at least 1000 kHz, or at least 1250 kHz.

A fourth aspect of the present disclosure is a monitoring device according to any one of the first aspect through the third aspect, wherein the sensor assembly (40) is configured to resolve at least four sub-areas (51, 52, 53, 54, 55, 56), at least nine sub-areas (51, 52, 53, 54, 55, 56), or at least 25 sub-areas (51, 52, 53, 54, 55, 56) on said workpiece (W).

A fifth aspect of the present disclosure is a monitoring device according to any one of the first aspect through the fourth aspect, wherein the sensor assembly (40) is configured to resolve at most 121 sub-areas (51, 52, 53, 54, 55, 56), at most 100 sub-areas (51, 52, 53, 54, 55, 56), at most 81 sub-areas (51, 52, 53, 54, 55, 56), at most 64 sub-areas (51, 52, 53, 54, 55, 56), at most 49 sub-areas (51, 52, 53, 54, 55, 56), at most 36 sub-areas (51, 52, 53, 54, 55, 56), or at most 25 sub-areas (51, 52, 53, 54, 55, 56) on said workpiece (W).

A sixth aspect of the present disclosure is a monitoring device according to any one of the first aspect through the fifth aspect, wherein the sensor assembly (40) comprises one optical sensor (41, 42, 43, 44, 45, 46) per sub-area (51, 52, 53, 54, 55, 56).

A seventh aspect of the present disclosure is a monitoring device according to any one of the first aspect through the sixth aspect, wherein the optical sensors (41, 42, 43, 44, 45, 46) being photodiodes, in particular said optical sensors (41, 42, 43, 44, 45, 46) comprising silicon photodiodes and/or InGaAs photodiodes.

An eighth aspect of the present disclosure is a monitoring device according to the seventh aspect, wherein the photodiodes are part of a photodiode array.

A ninth aspect of the present disclosure is a monitoring device according to any one of the first aspect through the eighth aspect, wherein each of said optical sensors (41, 42, 43, 44, 45, 46) and/or their measurement signal comprising one or more of the following functionalities:
individually readable,
individually drivable,
individually amplifiable,
individually selectable,
individually switchable on and off, and/or
individually evaluable.

A tenth aspect of the present disclosure is a monitoring device according to any one of the first aspect through the ninth aspect, further comprising a varifocal lens or zoom lens.

An eleventh aspect of the present disclosure is a monitoring device according to any one of the first aspect through the tenth aspect, further comprising a controller (30) configured to evaluate measurement data of said sensor assembly (40), particularly to monitor and/or to control or to regulate, respectively, said sensor assembly based on said measurement data.

A twelfth aspect of the present disclosure is a monitoring device according to the eleventh aspect, wherein said controller (30) configured to evaluate said measurement data with the help of a neuronal network and/or artificial intelligence model and/or machine learning model.

A thirteenth aspect of the present disclosure is a monitoring device according to any one of the first aspect through the twelfth aspect, further comprising an optical fiber (47) for each of said optical sensors (41, 42, 43, 44, 45, 46) for directing process radiation (P) from a respective sub-area (51, 52, 53, 54, 55, 56) on said workpiece (W) to an associated optical sensor (41, 42, 43, 44, 45, 46).

A fourteenth aspect of the present disclosure is a monitoring device according to any one of the first aspect through the thirteenth aspect, further comprising: a beam splitter assembly (280) configured to couple out, from said process radiation (P), at least one first partial beam (301) so that there are at least a first and a second partial beam (301, 302) of said process radiation (P); a sensor assembly (440a) comprising at most or exactly one optical sensor, particularly a photodiode; said sensor assembly (440a) with said at most or exactly one optical sensor configured to measure said second partial beam (302) of said process radiation (P); and said sensor assembly (40) with said at least two optical sensors (41, 42, 43, 44, 45, 46) configured to measure said first partial beam (301) of the process radiation (P).

A fifteenth aspect of the present disclosure is a monitoring device according to the fourteenth aspect, wherein said first partial beam (301) and said second partial beam (302) comprising different wavelength ranges.

A sixteenth aspect of the present disclosure is a monitoring device according to the fourteenth aspect or the fifteenth aspect, wherein said first partial beam (301) comprising radiation in the wavelength range between 600 nm and 3000 nm.

A seventeenth aspect of the present disclosure is a monitoring device according to any one of the fourteenth aspect through the sixteenth aspect, wherein said beam splitter assembly (280) comprising a plurality of beam splitters (280a, 280b, 280c), configured to split said process radiation (P) into at least three partial beams (360a, 360b, 380a, 380b, 400a, 400b, 340b), at least five partial beams (360a, 360b, 380a, 380b, 400a, 400b, 340b), or at least seven partial beams (360a, 360b, 380a, 380b, 400a, 400b, 340b).

An eighteenth aspect of the present disclosure is a monitoring device according to any one of the fourteenth aspect through the seventeenth aspect, further comprising a second sensor assembly (440b, 420a, 420b, 400a, 400b, 460a) with at least two optical sensors (41, 42, 43, 44, 45, 46), configured to resolve at least two sub-areas (51, 52, 53, 54, 55, 56) on said workpiece (W), said second sensor assembly (440b, 420a, 420b, 400a, 400b, 460a), with at least two optical sensors (41, 42, 43, 44, 45, 46), configured to measure a partial beam (360a, 360b, 380a, 380b, 400a, 400b, 340b) of the process radiation (P) comprising radiation in the wavelength range between 780 nm and 3000 nm, preferably 780 nm and 1400 nm, between 350 nm and 850 nm, or the wavelength of the energy beam.

A nineteenth aspect of the present disclosure is a monitoring device according to any one of the fourteenth aspect through the eighteenth aspect, wherein the monitoring device comprising at least two, at least three, at least four, or at least five sensor assemblies (440b, 420a, 420b, 400a, 400b, 460a) with at most or exactly one optical sensor, particularly a photodiode.

A twentieth aspect of the present disclosure is an energy-beam machining head (10) for radiating an energy beam (L) onto a workpiece (W), the energy-beam machining head (10) comprising the monitoring device (70) of one of the first aspect through the nineteenth aspect.

A twenty first aspect of the present disclosure is an energy-beam machining head according to the twentieth aspect, further comprising a scanner device for deflecting the energy beam (L) on the workpiece (W).

A twenty second aspect of the present disclosure is an energy-beam machining head according to the sixteenth aspect or the twentieth aspect, wherein the monitoring device (70) arranged on or in the energy-beam machining head (10) such that a beam path of the sensor assembly (40) extends coaxially with the beam path of the energy beam (L) at least in parts.

A twenty third aspect of the present disclosure is a method of monitoring an energy-beam machining process by a monitoring device (70), particularly by the monitoring device (70) according to any one of the first aspect through the nineteenth aspect, the method comprising the steps: radiating an energy beam (L) onto a workpiece (W), so that the workpiece (W) is being heated and process radiation (P) occurs, and measuring, by a sensor assembly (40) of the monitoring device (70), the process radiation (P) emanating from the workpiece (W); wherein, by the sensor assembly (40), at least two sub-areas (51, 52, 53, 54, 55, 56) are resolved on the workpiece (W) and each of the sub-areas (51, 52, 53, 54, 55, 56) is sampled with a frequency of at least 1 kHz.

A twenty fourth aspect of the present disclosure is a method according to the twenty third aspect, further comprising: measuring, by the sensor assembly (40), the process radiation (P) emanating from the workpiece (W) with all the sub-areas (51, 52, 53, 54, 55, 56) resolved by the sensor assembly (40), selecting a subset of the sub-areas (51, 52, 53, 54, 55, 56), and measuring, by the sensor assembly (40), the process radiation (P) emanating from the workpiece (W) with the selected sub-areas (51, 52, 53, 54, 55, 56).

1. A monitoring device for monitoring an energy-beam machining process on a workpiece, the monitoring device comprises:
a sensor assembly for measuring process radiation occurring at the energy-beam machining process, the sensor assembly comprises at least two optical sensors and is configured to resolve at least two sub-areas on the workpiece, and
wherein the sensor assembly is configured to sample each of the sub-areas with a frequency fu of at least 1 kHz.

2. The monitoring device of claim 1, wherein the sensor assembly is configured to sample each of the sub-areas with a frequency fu of at least 5 kHz.

3. The monitoring device of claim 1, wherein the sensor assembly is configured to sample each of the sub-areas with a frequency fu of fu = f0/u, wherein u is the number of the sub-areas and f0 is the overall frequency, and
wherein the overall frequency f0 is at least 100 kHz.

4. The monitoring device of claim 1, wherein the sensor assembly is configured to resolve at least four sub-areas on the workpiece.

5. The monitoring device of claim 1, wherein the sensor assembly is configured to resolve at most 121 sub-areas on the workpiece.

6. The monitoring device of claim 1, wherein the sensor assembly comprises one optical sensor per each of the sub-areas.

7. The monitoring device of claim 1, wherein the at least two optical sensors are photodiodes.

8. The monitoring device of claim 7, wherein the photodiodes are part of a photodiode array.

9. The monitoring device of claim 1, wherein each of the at least two optical sensors and/or their measurement signal comprising one or more of the following functionalities:
individually readable,
individually drivable,
individually amplifiable,
individually selectable,
individually switchable on and off, and/or
individually evaluable.

10. The monitoring device of claim 1, further comprising a varifocal lens or zoom lens.

11. The monitoring device of claim 1, further comprising a controller configured to evaluate measurement data of the sensor assembly to monitor and/or to control or to regulate, respectively, the sensor assembly based on the measurement data.

12. The monitoring device of claim 11, wherein the controller is configured to evaluate the measurement data with a neuronal network and/or artificial intelligence model and/or machine learning model.

13. The monitoring device of claim 1, further comprising an optical fiber for each of the at least two optical sensors for directing process radiation from a respective sub-area on the workpiece to an associated optical sensor.

14. The monitoring device of claim 1, further comprising:
a beam splitter assembly configured to couple out, from said process radiation, at least one first partial beam so that there are at least a first partial beam and a second partial beam of the process radiation;
a sensor assembly comprising at most or exactly one optical sensor;
the sensor assembly with the at most or exactly one optical sensor configured to measure the second partial beam of the process radiation; and
the sensor assembly with the at least two optical sensors configured to measure the first partial beam of the process radiation.

15. The monitoring device of claim 14, wherein the first partial beam and the second partial beam comprise different wavelength ranges.

16. The monitoring device of claim 14, wherein the first partial beam comprises radiation in a wavelength range between 600 nm and 3000 nm.

17. The monitoring device of claim 14, wherein the beam splitter assembly comprises a plurality of beam splitters configured to split the process radiation into at least three partial beams.

18. The monitoring device of claim 14, further comprising a second sensor assembly with at least two optical sensors, the second sensor assembly configured to resolve at least two sub-areas on the workpiece, the second sensor assembly, with the at least two optical sensors, configured to measure a partial beam of the process radiation comprising radiation in a wavelength range between 780 nm and 3000 nm or a wavelength of the energy beam.

19. The monitoring device of claim 14, further comprising at least two sensor assemblies with at most or exactly one optical sensor.

20. An energy-beam machining head for radiating an energy beam onto a workpiece, the energy-beam machining head comprising the monitoring device of claim 1.

21. The energy-beam machining head of claim 20, further comprising a scanner device for deflecting the energy beam on the workpiece.

22. The energy-beam machining head of claim 20, wherein the monitoring device is arranged on or in the energy-beam machining head such that a beam path of the sensor assembly extends coaxially with the beam path of the energy beam at least in parts.

23. A method of monitoring an energy-beam machining process by a monitoring device, the method comprising the steps:
radiating an energy beam onto a workpiece, so that the workpiece is heated and process radiation occurs, and
measuring, by a sensor assembly of the monitoring device, the process radiation emanating from the workpiece;
wherein, by the sensor assembly, at least two sub-areas are resolved on the workpiece and each of the sub-areas is sampled with a frequency of at least 1 kHz.

24. The method of claim 23, further comprising:
measuring, by the sensor assembly, the process radiation emanating from the workpiece with all the sub-areas resolved by the sensor assembly,
selecting a subset of the sub-areas, and
measuring, by the sensor assembly, the process radiation emanating from the workpiece with the selected sub-areas.
